(19) United States
(12) Patent Application Publication
(10) Pub. No.: US 2022/0266263 A1
(43) Pub. Date: Aug. 25, 2022

(54) COLLECTOR COMPOSITION

(71) Applicant: BASF SE, Ludwigshafen am Rein (DE)

(72) Inventors: Alexej Michailovski, Ludwigshafen (DE); Gabriela Budemberg, Jacarei (BR); Rostislav Kamkin, Moscow (RU); Juergen Tropsch, Ludwigshafen (DE)

(21) Appl. No.: 17/628,978

(22) PCT Filed: Jul. 24, 2020
(86) PCT No.: PCT/EP2020/070957

§ 371 Date: Jan. 21, 2022

(30) Foreign Application Priority Data
Jul. 24, 2019 (RU) PCT/RU2019/000519

(51) Int. Cl. B03D 1/01; B03D 1/016; B03D 1/008; B03D 1/02

(52) U.S. Cl. CPC B03D 1/01; B03D 1/016; B03D 1/008; B03D 2203/02; B03D 2201/005; B03D 2201/007; B03D 2201/06; B03D 1/025

(57) ABSTRACT

Presently claimed invention is directed to a collector composition for the beneficiation of a mineral comprising at least one component (A) selected from the group consisting of anionic (A1) surfactants, cationic (A2) surfactants, ampholytic (A3) surfactants and non-ionic surfactants (A4), and at least one component (B) selected from the group consisting of alkoxylated polyalkyleneimine (B1) and alkoxylated hexamethylene diamine (B2).

### FIELD OF THE INVENTION

The present invention relates to a composition for the beneficiation of a mineral, their use in flotation processes and a method for the beneficiation of mineral using said composition.

### BACKGROUND OF THE INVENTION

Beneficiation of minerals through flotation requires grinding of the ore to liberate valuable components. Ores that contain fine friable silicates such as clays and serpentine lead to the generation of ultra-fine particles during the grinding. These ultra-fine particles could bind to the crystal surfaces of the valuable minerals and prevent them from being floated, or else activate undesired minerals to be floated alongside the desired minerals.

US 2014/0048454 A1 relates to fatty amido amine collectors for the beneficiation of aqueous suspensions of ores by flotation, especially silicate containing-ores. It discloses fatty acid amidoamines as collectors for the beneficiation of the silicate containing ores.

US 2014/0144290 A1 discloses a collector composition comprising one or more etheramines and one or more amidoamines for the beneficiation of ores. This composition helps to reduce the particulates in the treated mixture.

US 2015/0096925 A1 discloses a collector composition which includes one or more amidoamines and one or more amines. This mixture helps to purify the minerals containing silicate such as quartz, mica, feldspar, muscovite, and biotite.

WO 02/066168 A1 relates to a process for separation of valuable minerals from ores, in which the suspensions or the slurries of these ores, are treated with particles which are magnetic and/or capable of floating and/or reporting to the froth phase of flotation in aqueous solutions. After the addition of the magnetic particles and/or the particles capable of floating, a magnetic field is applied so that the agglomerates are separated from the mixture. However, the extent to which the magnetic particles are bound to the ore and the strength of the bond is not sufficient for the process to be carried out with a satisfactorily high yield and effectiveness.

WO 1994/026419 A1 describes the combination of quaternary ammonium salts with an adduct of an alkylene oxide and an amine compound, for which the sum of all alkylene oxide groups is 10 to 40. This combination achieves an improvement in calcium carbonate beneficiation; leading to a very high yield and/or a high selectivity.

WO 2007/122148 A1 discloses the combination of at least two collectors, belonging to fatty quaternary ammonium salts or fatty bis-imidazoline quaternary ammonium compounds, and more preferentially a combination of two quaternary ammonium salts for the reverse froth flotation of calcite ore.

US 2014/0048453 A1 relates to fatty alkoxylated polyamine collectors for the beneficiation of aqueous suspensions of ores by flotation, particularly in reverse flotation processes for the beneficiation of silicates containing-ores.

WO1999/067352 describes alkoxylated polyalkyleneimine hydrophobic soil dispersants which are suitable for use as soil dispersant in detergent applications. The soil dispersants act by sequestering dirt once it is dissolved or dispersed in the laundry liquor and keeps the suspended soil in the laundry liquor where it can be carried away during the normal rinsing process.

The processes for separating a desired valuable matter containing material from a mixture comprising this desired material and further undesired materials that are disclosed in the prior art can still be improved in respect of the separation efficiency, the yield of desired valuable matter and/or in respect of the grade of the obtained desired valuable material in agglomerates comprising the desired valuable matter containing material. An improvement of this separation process will further increase the efficiency of the whole valuable matter recovery process chain. One of the problems encountered with the beneficiation of minerals through flotation for recovering valuable minerals is associated with the grinding of the ore to liberate valuable components. Ores that contain fine friable silicates such as clays and serpentine lead to the generation of ultra-fine particles during the grinding. These ultra-fine particles such as silicates could bind to the crystal surfaces of the valuable minerals and prevent them from being floated, or else activate the floatation of undesired minerals and silicates.

Thus, it is an object of the presently claimed invention to provide a composition that can be used in a low amount for the beneficiation of minerals containing ultra-fine friable silicates such as clays and serpentine.

### SUMMARY OF THE INVENTION

Surprisingly, it was found that minerals containing ultra-fine friable silicates such as clays and serpentine can be concentrated in a high yield and grade by using a composition comprising alkoxylated polyalkyleneimine and/or alkoxylated hexamethylene diamine in comparatively low amounts. In some applications, the composition was also found to surprisingly reduce the Fe₂O₃ impurities as well.

Thus, in a first aspect, the presently claimed invention is directed to the use of a composition for the beneficiation of ores containing silicates, wherein the composition comprises:

A. at least one component (A), and
B. at least one component (B),
wherein the at least one component (A) is selected from the group consisting of anionic surfactants (A1), cationic surfactants (A2), ampholytic surfactants (A3) and non-ionic surfactants (A4), and
the at least one component (B) comprises a polymer selected from the group consisting of alkoxylated polyalkyleneimine (B1) and alkoxylated hexamethylene diamine (B2).

In a second aspect, the presently claimed invention is directed to a direct flotation process for the beneficiation of ores containing friable silicates comprising the steps of:

a. comminution of ores,
b. optionally, conditioning of the ores with depressants and/or activators,
c. pH adjustment,
d. Component (B) addition
e. component (A) addition,
f. flotation,
g. collection of the valuable mineral in the froth,
wherein the components (A) and (B) are defined as above.

In a third aspect, the presently claimed invention is directed to a reverse flotation process for the beneficiation of ores containing undesirable minerals (including friable silicates), by collection of undesirable minerals from the ore in the froth, comprising the steps of:

a. comminution of ore,
b. optionally, conditioning of the ore with depressants and/or activators,
c. pH adjustment,
d. component (B) addition
e. component (A) addition,
f. flotation,
g. collection of undesirable minerals in the froth,
h. recovering of the valuable mineral in the cell underflow,
wherein as the components (A) and (B) are defined as above.

In fourth aspect, the presently claimed invention is directed to a composition for the beneficiation of ores containing silicates comprising:

A. at least one component (A), and
B. at least one component (B),
wherein the at least one component (A) is selected from the group consisting of anionic (A1) surfactants, cationic (A2) surfactants, ampholytic (A3) surfactants and non-ionic surfactants (A4), and
the at least one component (B) comprises a polymer selected from the group consisting of alkoxylated polyalkyleneimine (B1) and alkoxylated hexamethylene diamine (B2).

### DETAILED DESCRIPTION OF THE INVENTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

As used herein, the term “flotation” relates to the separation of minerals based on differences in their hydrophobicity and their different ability to adhere or attach to air bubbles. The aim of flotation as mineral processing operation is to selectively separate certain materials. In particular, the flotation is used for the beneficiation of phosphates from phosphate-containing mineral. Flotation comprises froth flotation methods like for example direct flotation or reverse flotation. Direct flotation of phosphates refers to methods, wherein particular phosphates are collected in the froth and the impurities remain in the slurry. Reverse flotation or inverse flotation of phosphates relates to methods, wherein the impurities as undesired materials are collected in the froth and the phosphates remain in the slurry as cell product. In particular, reverse flotation of phosphates is similar to direct flotation of carbonates.

As used herein, the term “cell product” has the similar meaning as cell underflow or slurry and means the product remaining in the cell, in particular in reverse flotation processes.

As used herein, the term “froth product” means the product obtained in the froth, in particular in direct flotation processes.

As used herein, the term “concentrate” has the meaning of flotation product and refers to the material obtained as cell product (valuable material) in reverse flotation processes as well as to froth product as the material obtained in the froth (valuable material) in direct flotation processes.

As used herein, the term “tailings” or “flotation tailings” is understood economically and means the undesired products and impurities which are removed in direct or reverse flotation processes.

As used herein, the term “collector” relates to substances with the ability to adsorb to a mineral particle and to make the mineral particle hydrophobic in order to enable the mineral particle to attach to air bubbles during flotation. The collector may comprise, for example at least one or two or three different collectors. A collector composition may comprise collector components which are named for example primary, secondary, ternary collector and can influence the collector composition properties. A collector composition comprises in particular mixtures of fatty acids and surfactants. The collectors can in particular be surface-active, can have emulsification properties, can act as wetting agent, can be a solubility enhancer and/or a foam or froth regulator.

As used herein, the term “grade” relates to the content of the desired mineral or valuable or targeted material in the obtained concentrate after the enrichment via flotation. In particular, the grade is the concentration of P₂O₅ obtained by the phosphate flotation process. The grade in particular refers to the P₂O₅ concentration and describes the content of P₂O₅ in the concentrate (w/w), particularly in the froth product at direct phosphate flotation and the content of P₂O₅ in the cell product in reverse phosphate flotation.

As used herein, the term “recovery” refers to the percentage of valuable material recovered after the enrichment via flotation. The relationship of grade (concentration) vs. recovery (amount) is a measure for the selectivity of froth flotation. The selectivity increases with increasing values for grade and/or recovery. With the selectivity the effectiveness/performance of the froth flotation can be described.

In a first embodiment, the presently claimed invention is directed to the use of a composition for the beneficiation of ores containing silicate impurities, wherein the composition comprises:

A. at least one component (A), and
B. at least one component (B),
wherein the at least one component (A) is selected from the group consisting of anionic surfactants (A1), cationic surfactants (A2), ampholytic surfactants (A3) and non-ionic surfactants (A4), and
the at least one component (B) comprises a polymer selected from the group consisting of alkoxylated polyalkyleneimine (B1) and alkoxylated hexamethylene diamine (B2);
preferably, the composition comprises:
A. at least one component (A), and
B. at least one component (B),
wherein the at least one component (A) is selected from the group consisting of anionic surfactants (A1), cationic surfactants (A2) and ampholytic surfactants (A3), and
the at least one component (B) comprises a polymer selected from the group consisting of alkoxylated polyalkyleneimine (B1) and alkoxylated hexamethylene diamine (B2); more preferably, the composition comprises:
A. at least one component (A), and
B. at least one component (B),
wherein the at least one component (A) is selected from the group consisting of anionic surfactants (A1) and cationic surfactants (A2), and
the at least one component (B) comprises a polymer selected from the group consisting of alkoxylated polyalkyleneimine (B1) and alkoxylated hexamethylene diamine (B2); and even more preferably, the composition comprises:
A. at least one component (A), and
B. at least one component (B),
wherein the at least one component (A) is selected from the group consisting of anionic surfactants (A1) and cationic surfactants (A2), and
the at least one component (B) comprises a polymer of alkoxylated polyalkyleneimine (B1); most preferably, the composition comprises:
A. at least one component (A), and
B. at least one component (B),
wherein the at least one component (A) is selected from the group consisting of anionic surfactants (A1) and cationic surfactants (A2), and
the at least one component (B) comprises a polymer selected from the group consisting of ethoxylated polyalkyleneimine (B1a) and propoxylated polyalkyleneimine (B1b); and in particular, the composition comprises:
A. at least one component (A), and
B. at least one component (B),
wherein the at least one component (A) is selected from the group consisting of anionic surfactants (A1) and cationic surfactants (A2), and
the at least one component (B) comprises a polymer of ethoxylated polyalkyleneimine (B1).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is an anionic surfactant (A1), and
the at least one component (B) comprises a polymer selected from the group consisting of alkoxylated polyalkyleneimine (B1) and alkoxylated hexamethylene diamine (B2).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is a cationic surfactant (A2), and
the at least one component (B) comprises a polymer selected from the group consisting of alkoxylated polyalkyleneimine (B1) and alkoxylated hexamethylene diamine (B2).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is an ampholytic surfactant (A3), and
the at least one component (B) comprises a polymer selected from the group consisting of alkoxylated polyalkyleneimine (B1) and alkoxylated hexamethylene diamine (B2).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is a non-ionic surfactant (A4), and
the at least one component (B) comprises a polymer selected from the group consisting of alkoxylated polyalkyleneimine (B1) and alkoxylated hexamethylene diamine (B2).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is an anionic surfactant (A1), and
the at least one component (B) comprises a polymer of alkoxylated polyalkyleneimine (B2).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is a cationic surfactant (A2), and
the at least one component (B) comprises a polymer of alkoxylated polyalkyleneimine (B1).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is an ampholytic surfactant (A3), and
the at least one component (B) comprises a polymer of alkoxylated polyalkyleneimine (B1).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is a non-ionic surfactant (A4), and
the at least one component (B) comprises a polymer of alkoxylated polyalkyleneimine (B1).

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is an anionic surfactant (A1), and
the at least one component (B) comprises a polymer of ethoxylated and/or propoxylated polyethyleneimine.

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is a cationic surfactant (A2), and
the at least one component (B) comprises a polymer of ethoxylated and/or propoxylated polyethyleneimine.

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is an ampholytic surfactant (A3), and
the at least one component (B) comprises a polymer of ethoxylated and/or propoxylated polyethyleneimine.

In another preferred embodiment, the presently claimed invention is directed to the use of a composition for the beneficiation of ores containing silicate impurities, wherein the composition comprises:

A. at least one component (A), and
B. at least one component (B),
wherein the at least one component (A) is a non-ionic surfactant (A4), and
the at least one component (B) comprises a polymer of ethoxylated and/or propoxylated polyethyleneimine.

In another preferred embodiment, the ore comprises at least one valuable material.

In another preferred embodiment, the valuable materials are selected from the group consisting of the oxide minerals such as haematite, magnetite, rutile, cassiterite, zirconia, chromite, titanomagnetite, pyrolusite etc, or sparingly soluble salt minerals, such as apatite, calcite.

In another preferred embodiment, the valuable materials are valuable silicates such as quartz, feldspar, mica types, or spodumene LiAl[Si₂O₆].

In another preferred embodiment, the valuable materials are the sulfides of Cu, Ni, Zn, Pb, Ag such as galena, sphalerite, chalcocite or a complex sulfide with each other or with iron, such as chalcopyrite (CuFeS₂) or pentlandite (NiFeS₂).

In another preferred embodiment, the valuable materials are the elements such as V, Nb, Ta, Th, Zr, etc in the form of complex oxides such as pyrochlore or tantalite.

In another preferred embodiment, the valuable elements are metals such as Ag, Au, Pt or Pd as native metals or alloys with Fe or as solid solutions in sulphide minerals such as pyrite, pyrrhotite, arsenopyrite, chalcopyrite or pentlandite.

In one preferred embodiment, the at least one valuable material containing element is present in the form of a physically separable mineral.

In one preferred embodiment, the ore minerals are in the form of oxides and carbonates of the metals and the nonmetals.

In a preferred embodiment, the at least one valuable matter containing material comprises ore minerals, preferably ore minerals such as sulfidic ore minerals for example galena (PbS), braggite (Pt, Pd, Ni)S, argentite (Ag₂S) or sphalerite (Zn, Fe)S, oxidic and/or carbonate-comprising ore minerals, for example apatite Ca₅(PO₄)₃(F,OH), azurite [Cu₃(CO₃)₂(OH)₂] or malachite [Cu₂[(OH)₂|CO₃]], rare earth metals comprising ore minerals like bastnaesite (Y, Ce, La)CO₃F, monazite (RE)PO₄ (RE=rare earth metal) or chrysocolla (Cu,Al)₂H₂Si₂O₃(OH)₄.n H₂O, and pyrochlore Ca₂Nb₂O₇.

In another preferred embodiment, the presently claimed invention is directed to the use of a composition for the beneficiation of the phosphates from the phosphate-containing mineral.

In a preferred embodiment, the phosphate-containing minerals are selected from the group consisting of phosphorites, apatites, frondelite and stewarite. In another preferred embodiment the apatites are selected form the group consisting of hydroxyapatite, fluoroapatite, chloroapatite, carbonatoapatite and bromoapatite.

In one embodiment of the process according to the presently claimed invention, the undesired material is silicate.

In another preferred embodiment, the use of the composition for beneficiation of ores containing silicate impurities, wherein the anionic surfactants (A1) are selected from compounds of formula (A1) or derivatives thereof,

[(G)ₘ(Z)ₙ]ₒ (A1),

wherein each G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, linear or branched, substituted or unsubstituted C₆-C₃₀-heterocycloalkyl and substituted or unsubstituted C₆-C₃₀-aralkyl;
each Z is independently selected from group consisting of

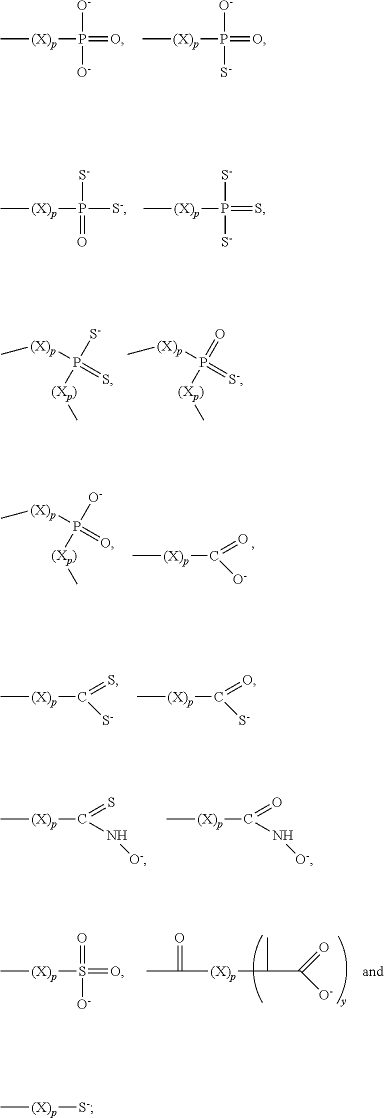

X is independently selected from the group consisting of O, S, NH and CH₂;
m is an integer in the range from 1 to 10;
n is an integer in the range from 1 to 10; and
o is in the range from 1 to 100;
y is in the range of 1 to 10; and
p is 0, 1 or 2;
more preferably, the anionic surfactants (A1) are selected from compounds of formula (A1) or derivatives thereof,

[(G)ₘ(Z)ₙ]ₒ (A1),

wherein each G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, substituted or unsubstituted C₆-C₃₀-heterocycloalkyl and substituted or unsubstituted C₆-C₃₀-aralkyl;
each Z is independently selected from group consisting of

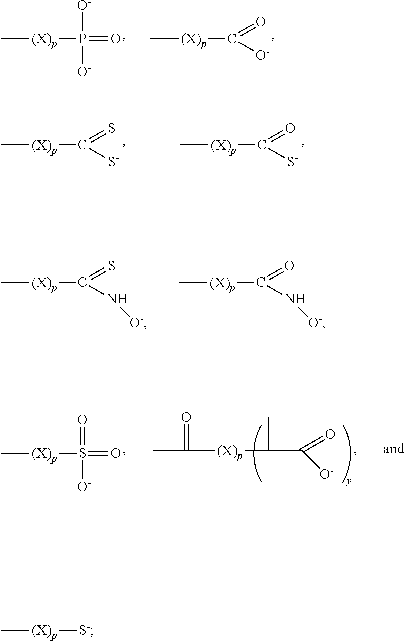

X is independently selected from the group consisting of O, S, NH and CH₂;
m is an integer in the range from 1 to 8;
n is an integer in the range from 1 to 8; and
o is in the range from 1 to 80;
y is in the range of 1 to 10; and
p is 0, 1 or 2;
even more preferably, the anionic surfactants (A1) are selected from compounds of formula (A1) or derivatives thereof,

[(G)ₘ(Z)ₙ]ₒ (A1),

wherein each G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, substituted or unsubstituted C₆-C₃₀-heterocycloalkyl and substituted or unsubstituted C₆-C₃₀-aralkyl;
each Z is independently selected from group consisting of

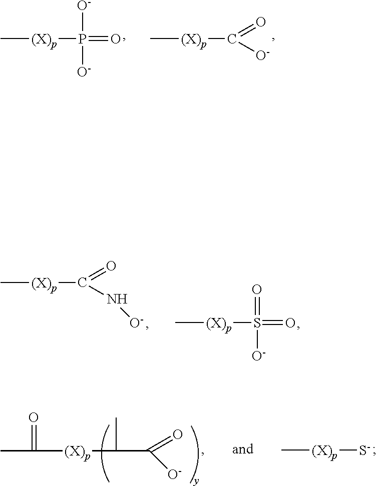

X is independently selected from the group consisting of O, S, NH and CH₂;
m is an integer in the range from 1 to 6;
n is an integer in the range from 1 to 6; and
o is in the range from 1 to 60;
y is in the range of 1 to 10; and
p is 0, 1 or 2;
most preferably, the anionic surfactants (A1) are selected from compounds of formula (A1) or derivatives thereof,

[(G)ₘ(Z)ₙ]ₒ (A1),

wherein each G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, substituted or unsubstituted C₆-C₃₀-heterocycloalkyl and substituted or unsubstituted C₆-C₃₀-aralkyl;
each Z is independently selected from group consisting of

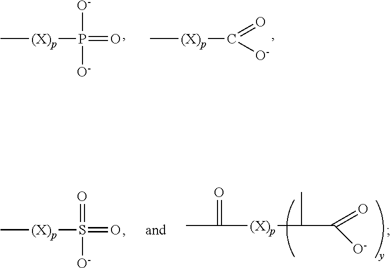

X is independently selected from the group consisting of O, S, NH and CH₂;
m is an integer in the range from 1 to 4;
n is an integer in the range from 1 to 4; and
o is in the range from 1 to 50;
y is in the range of 1 to 10; and
p is 0, 1 or 2; and
in particular preferably, the anionic surfactants (A1) are selected from compounds of formula (A1) or derivatives thereof,

[(G)ₘ(Z)ₙ]ₒ (A1),

wherein each G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, C₄-C₃₀-heteroalkenyl, substituted or unsubstituted C₆-C₃₀-heterocycloalkyl and substituted or unsubstituted C₆-C₃₀-aralkyl;
each Z is independently selected from group consisting of

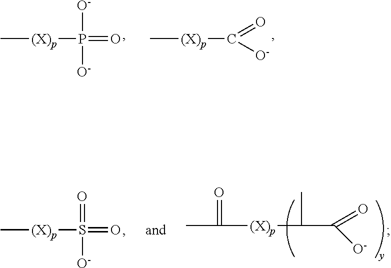

X is independently selected from the group consisting of O and CH₂;
m is an integer in the range from 1 to 2;
n is an integer in the range from 1 to 2;
o is in the range from 1 to 50;
y is in the range of 1 to 10; and
p is 0, 1 or 2.

In another preferred embodiment, the formula (A1) includes all the possible combinations of how each G and each Z may be attached to one another. This includes any linear attachment, such as in -G-G-Z-Z-, A-Z-A-Z-, -Z-G-Z-G- and the like; branched attachments, such as in

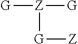

and the like; and circular attachments such as in

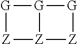

and the like. The skilled person is able to identify suitable attachment sites, such as substitution sites, in substituent A and Z that allow the attachment.

In another preferred embodiment, G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, substituted or unsubstituted C₈-C₃₀-heterocycloalkyl and substituted or unsubstituted C₈-C₃₀-aralkyl; more preferably, linear or branched, substituted or unsubstituted C₈-C₂₂-alkyl, linear or branched, substituted or unsubstituted C₈-C₂₂-alkenyl, linear or branched, substituted or unsubstituted C₈-C₂₂-heteroalkyl, substituted or unsubstituted C₆-C₂₀-aryl, substituted or unsubstituted C₆-C₂₀-cycloalkyl, linear or branched, substituted or unsubstituted C₈-C₂₂-heteroalkenyl, substituted or unsubstituted C₆-C₃₀-heterocycloalkyl and substituted or unsubstituted C₆-C₃₀-aralkyl; even more preferably, linear or branched, substituted or unsubstituted C₁₀-C₂₂-alkyl, linear or branched, substituted or unsubstituted C₁₀-C₂₂-alkenyl, linear or branched, substituted or unsubstituted C₁₀-C₂₂-heteroalkyl, substituted or unsubstituted C₆-C₁₆-aryl, substituted or unsubstituted C₆-C₁₆-cycloalkyl, linear or branched, substituted or unsubstituted C₁₀-C₂₂-heteroalkenyl, substituted or unsubstituted C₆-C₂₀-heterocycloalkyl and substituted or unsubstituted C₆-C₂₀-aralkyl; most preferably, linear or branched, substituted or unsubstituted C₁₀-C₂₀-alkyl, linear or branched, substituted or unsubstituted C₁₀-C₂₀-alkenyl, linear or branched, substituted or unsubstituted C₁₀-C₂₀-heteroalkyl, substituted or unsubstituted C₆-C₁₀-aryl, substituted or unsubstituted C₆-C₁₀-cycloalkyl, linear or branched, substituted or unsubstituted C₁₀-C₂₀-heteroalkenyl, substituted or unsubstituted C₆-C₂₀-heterocycloalkyl and substituted or unsubstituted C₆-C₁₈-aralkyl; and in particular preferably, linear or branched, substituted or unsubstituted C₁₂-C₁₈-alkyl, linear or branched, substituted or unsubstituted C₁₂-C₁₈-alkenyl, linear or branched, substituted or unsubstituted C₁₂-C₁₈-heteroalkyl, substituted or unsubstituted C₆-C₁₀-aryl, substituted or unsubstituted C₆-C₁₀-cycloalkyl, linear or branched, substituted or unsubstituted C₁₂-C₁₈-heteroalkenyl, substituted or unsubstituted C₆-C₁₀-heterocycloalkyl and substituted or unsubstituted C₆-C₁₈-aralkyl; and even in particular preferably, linear or branched, substituted or unsubstituted C₁₄-C₁₆-alkyl, linear or branched, substituted or unsubstituted C₁₄-C₁₆-alkenyl, linear or branched, substituted or unsubstituted C₁₄-C₁₆-heteroalkyl, substituted or unsubstituted C₆-C₁₀-aryl, substituted or unsubstituted C₆-C₁₀-cycloalkyl, linear or branched, substituted or unsubstituted C₁₄-C₁₆-heteroalkenyl, substituted or unsubstituted C₈-C₁₀-heterocycloalkyl and substituted or unsubstituted C₈-C₁₈-aralkyl.

In another preferred embodiment, G is independently selected from the group consisting of linear or branched, substituted or unsubstituted C₄-C₃₀-alkyl and linear or branched, substituted or unsubstituted C₄-C₃₀-alkenyl; more preferably selected from the group consisting of linear or branched, substituted or unsubstituted C₈-C₂₂-alkyl and linear or branched, substituted or unsubstituted C₈-C₂₂-alkenyl.

In another preferred embodiment, Z is an anionic selected from group consisting of

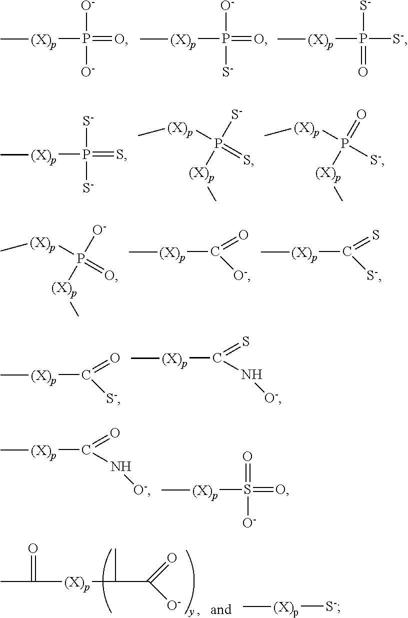

wherein X is independently selected from the group consisting of O, S, NH, CH₂; and each p is independently selected from 0, 1 or 2; y is in the range of 1 to 10; more preferably, Z is an anionic selected from group consisting of

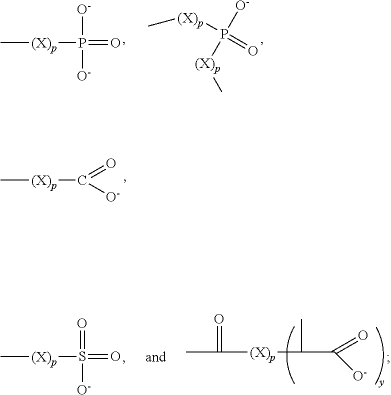

wherein X is independently selected from the group consisting of 0, CH₂; and each p is independently selected from 0, 1 or 2 y is in the range of 1 to 10; most preferably, Z is an anionic selected from group consisting of

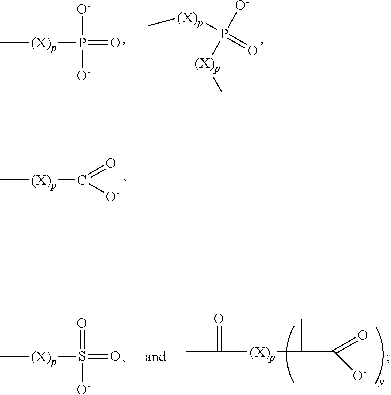

wherein X is independently selected from the group consisting of 0, CH₂; and each p is independently selected from 0, 1 or 2 and y is in the range of 1 to 6.

In another preferred embodiment, the anionic group is present as a salt with at least one cation wherein the at least one cationic counter ion is selected from the group consisting of hydrogen, alkali metal ions, alkali earth metal ions, N(R¹)₄⁺; wherein each R¹ is independently selected from the group consisting of hydrogen, linear or branched C₁-C₈-alkyl, hydroxy-substituted linear C₁-C₈-alkyl, linear or branched C₁-C₈-heteroalkyl.

In another preferred embodiment, the anionic group is present as a salt with at least one cation wherein the at least one cationic counter ion is selected from the group consisting of sodium and potassium metal ions.

In another preferred embodiment, the anionic surfactants (A1) are selected from the group consisting of fatty acids, alkyl sulfates, alkyl sulfosuccinates, alkyl sulfosuccinamates, acyl sarcosides, N-acylaminoacids, alkyl benzene sulfonates, alkyl sulfonates, petroleum sulfonates, acyl lactylates and salts thereof.

In another preferred embodiment, the fatty acid is linear or branched, saturated or unsaturated C₄-C₃₀ fatty acid; more preferably, the fatty acid is linear or branched, saturated or unsaturated C₈-C₂₂-fatty acid; most preferably, the fatty acid is linear or branched, saturated or unsaturated C₁₂-C₁₈-fatty acid; and in particular preferably, the fatty acid is linear or branched, saturated or unsaturated C₁₆-C₁₈-fatty acids.

In another preferred embodiment, the fatty acid is obtained from vegetable or animal fats and oils.

In another preferred embodiment, the linear or branched, saturated or unsaturated C₄-C₃₀ fatty acids are selected from the group consisting of hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, isostearic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid and mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends.

In another preferred embodiment, the fatty acid is generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends.

In another preferred embodiment, the alkyl sulfate is the sulfuric acid semi esters of linear or branched, saturated or unsaturated C₄-C₃₀ fatty alcohol; more preferably, the alkyl sulfate is the sulfuric acid semi esters of linear or branched, saturated or unsaturated C₈-C₂₂-fatty alcohol; most preferably, the alkyl sulfate is the sulfuric acid semi esters of linear or branched, saturated or unsaturated C₁₂-C₁₈-fatty alcohol; and in particular preferably, the alkyl sulfate is the sulfuric acid semi esters of linear or branched, saturated or unsaturated C₁₆-C₁₈-fatty alcohol.

In another preferred embodiment, the alkyl sulfosuccinate is the sulfosuccinic acid semi esters of linear or branched, saturated or unsaturated C₄-C₃₀ fatty alcohol; more preferably, the alkyl sulfosuccinate is the sulfosuccinic acid semi esters of linear or branched, saturated or unsaturated C₈-C₂₂-fatty alcohol; most preferably, the alkyl sulfosuccinate is the sulfosuccinic semi esters of linear or branched, saturated or unsaturated C₁₂-C₁₈-fatty alcohol; and in particular preferably, the alkyl sulfosuccinate is the sulfosuccinic semi esters of linear or branched, saturated or unsaturated C₁₆-C₁₈ fatty alcohol.

In another preferred embodiment, the alkyl sulfosuccinamate is the sulfosuccinic acid semi amides of linear or branched, saturated or unsaturated C₄-C₃₀ fatty primary or secondary amines; more preferably, the alkyl sulfosuccinamate is the sulfosuccinic acid semi amides of linear or branched, saturated or unsaturated C₈-C₂₂-fatty primary or secondary amines; most preferably, the alkyl sulfosuccinamate is the sulfosuccinic semi amides of linear or branched, saturated or unsaturated C₁₂-C₁₈-fatty primary or secondary amines; and in particular preferably, the alkyl sulfosuccinamate is the sulfosuccinic semi amides of linear or branched, saturated or unsaturated C₁₆-C₁₈-fatty primary or secondary amines.

In another preferred embodiment, the primary amines suitable for use in the preparation of the alkyl sulfosuccinamates are n-octyl amine, n-decyl amine, n-dodecyl amine, n-tetradecyl amine, n-hexadecyl amine, n-octadecyl amine, n-eicosyl amine, n-docosyl amine, n-hexadecenyl amine and n-octadecenyl amine.

In another preferred embodiment, the secondary amines suitable for use in the preparation of the alkyl sulfosuccinamates are N-methyl and N-ethyl derivatives of n-octyl amine, n-decyl amine, n-dodecyl amine, n-tetradecyl amine, n-hexadecyl amine, n-octadecyl amine, n-eicosyl amine, n-docosyl amine, n-hexadecenyl amine and n-octadecenyl amine.

In another preferred embodiment, the acyl sarcosides are a compound of formula (A1a)

G¹-C(═O)—NR—CH₂—COO⁻ formula (A1a)

wherein G¹ is linear or branched, saturated or unsaturated C₄-C₃₀ hydrocarbon chain and R is linear or branched, saturated or unsaturated C₁-C₃₀ hydrocarbon chain; more preferably, G¹ is linear or branched, saturated or unsaturated C₈-C₂₄ hydrocarbon chain and R is linear or branched, saturated or unsaturated C₁-C₂₀ hydrocarbon chain; even more preferably, G¹ is linear or branched, saturated or unsaturated C₁₂-C₂₄ hydrocarbon chain and R is linear or branched, saturated or unsaturated C₁-C₁₀ hydrocarbon chain; most preferably, G¹ is linear or branched, saturated or unsaturated C₁₄-C₂₀ hydrocarbon chain and R is linear or branched, saturated or unsaturated C₁-C₆ hydrocarbon chain; and in particular, G¹ is linear or branched, saturated or unsaturated C₁₆-C₂₀ hydrocarbon chain and R is linear or branched, saturated or unsaturated C₁-C₆ hydrocarbon chain.

In another preferred embodiment, the N-acyl aminoacid is a compound of formula (A1b)

G²-C(═O)—NR—CH(R¹)—COO⁻ formula (A1b)

wherein G² is linear or branched, saturated or unsaturated C₄-C₃₀ hydrocarbon chain, R is linear or branched, saturated or unsaturated C₁-C₃₀ hydrocarbon chain and R¹ is selected from the group consisting of —CH₃, —CH(CH₃)CH₂CH₃, —CH(CH₃)CH₃, —CH(CH₃)₂, —CH₂CH₂SCH₃, —CH₂Ph, —CH₂(Indolyl), —CH₂—CH₄—OH, —CH₂SH, —CH₂CH₂C(═O)NH₂, —CH₂(OH) and —CH(OH)CH₃; more preferably, G² is linear or branched, saturated or unsaturated C₈-C₂₄ hydrocarbon chain, R is linear or branched, saturated or unsaturated C₁-C₂₀ hydrocarbon chain and R¹ is selected from the group consisting of —CH₃, —CH(CH₃)CH₂CH₃, —CH₂, —CH(CH₃)CH₃, —CH(CH₃)₂, —CH₂CH₂SCH₃, —CH₂Ph, —CH₂(Indolyl), —CH₂—C₄H₄—OH, —CH₂SH, —CH₂CH₂C(═O)NH₂, —CH₂(OH) and —CH(OH)CH₃; even more preferably, G² is linear or branched, saturated or unsaturated C₁₂-C₂₄ hydrocarbon chain, R is linear or branched, saturated or unsaturated C₁-C₁₀ hydrocarbon chain and R¹ is selected from the group consisting of —CH₃, —CH(CH₃)CH₂CH₃, —CH₂, —CH(CH₃)CH₃, —CH(CH₃)₂, —CH₂CH₂SCH₃, —CH₂Ph, —CH₂(Indolyl), —CH₂—C₄H₄—OH, —CH₂SH, —CH₂CH₂C(═O)NH₂, —CH₂(OH) and —CH(OH)CH₃; most preferably, G² is linear or branched, saturated or unsaturated C₁₄-C₂₀ hydrocarbon chain, R is linear or branched, saturated or unsaturated C₁-C₆ hydrocarbon chain and R¹ is selected from the group consisting of —CH₃, —CH(CH₃)CH₂CH₃, —CH₂, —CH(CH₃)CH₃, —CH(CH₃)₂, —CH₂CH₂SCH₃, —CH₂Ph, —CH₂(Indolyl), —CH₂—C₄H₄—OH, —CH₂SH, —CH₂CH₂C(═O)NH₂, —CH₂(OH) and —CH(OH)CH₃; and in particular, G² is linear or branched, saturated or unsaturated C₁₆-C₂₀ hydrocarbon chain, R is linear or branched, saturated or unsaturated C₁-C₆ hydrocarbon chain and R¹ is selected from the group consisting of —CH₃, —CH(CH₃)CH₂CH₃, —CH₂, —CH(CH₃)CH₃, —CH(CH₃)₂, —CH₂CH₂SCH₃, —CH₂Ph, —CH₂(Indolyl), —CH₂—C₄H₄—OH, —CH₂SH, —CH₂CH₂C(═O)NH₂, —CH₂(OH) and —CH(OH)CH₃.

In another preferred embodiment, the alkyl benzene sulfonate is a compound of formula (A1c)

G³-C₆H₄—SO₃⁻ formula (A1c)

wherein G³ is linear or branched, saturated or unsaturated C₄-C₃₀ hydrocarbon chain.

In another preferred embodiment, the alkyl sulfonate is a linear or branched, saturated or unsaturated C₄-C₃₀ hydrocarbon chain having at least one sulfonate group; more preferably, linear or branched, saturated or unsaturated C₈-C₂₄ hydrocarbon chain having at least one sulfonate group; even more preferably, linear or branched, saturated or unsaturated C₈-C₂₂ hydrocarbon chain having at least one sulfonate group; most preferably, linear or branched, saturated or unsaturated C₁₂-C₂₂ hydrocarbon chain having at least one sulfonate group; and in particular preferably, more preferably, linear or branched, saturated or unsaturated C₁₂-C₁₈ hydrocarbon chain having at least one sulfonate group.

In another preferred embodiment, the petroleum sulfonates suitable for use as are anionic surfactant (A1) obtained from lubricating oil fractions, generally by sulfonation with sulfur trioxide or oleum. Preferably by sulfonation of lubricating oil fractions having C₄-C₃₀ hydrocarbon chain with sulfur trioxide or oleum; more preferably by sulfonation of lubricating oil fractions having C₈-C₂₄ hydrocarbon chain with sulfur trioxide or oleum; most more preferably by sulfonation of lubricating oil fractions having C₁₂-C₂₂ hydrocarbon chain with sulfur trioxide or oleum; and in particular preferably by sulfonation of lubricating oil fractions having C₁₂-C₁₈ hydrocarbon chain with sulfur trioxide or oleum.

In another preferred embodiment, the acyl lactylate is a compound of formula (A1d)

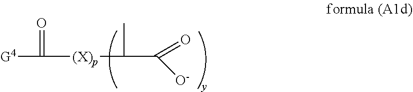

wherein G⁴ is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, substituted or unsubstituted C₆-C₃₀-heterocycloalkyl and substituted or unsubstituted C₆-C₃₀-aralkyl;

### X is O;

y is in the range of 1 to 10; and
p is 1;
more preferably, G⁴ is independently selected from the group consisting of linear or branched, substituted or unsubstituted C₈-C₂₄-alkyl, linear or branched, substituted or unsubstituted C₈-C₂₄-alkenyl, linear or branched, substituted or unsubstituted C₈-C₂₄-heteroalkyl, substituted or unsubstituted C₆-C₂₀-aryl, substituted or unsubstituted C₆-C₂₀-cycloalkyl, linear or branched, substituted or unsubstituted C₈-C₂₄-heteroalkenyl, substituted or unsubstituted C₆-C₂₀-heterocycloalkyl and substituted or unsubstituted C₆-C₂₀ aralkyl;

### X is O;

y is in the range of 1 to 6; and
p is 1; and
most preferably, G⁴ is independently selected from the group consisting of linear or branched, substituted or unsubstituted C₈-C₂₂-alkyl, linear or branched, substituted or unsubstituted C₈-C₂₂-alkenyl, linear or branched, substituted or unsubstituted C₈-C₂₂-heteroalkyl, substituted or unsubstituted C₆-C₂₀-aryl;

### X is O;

y is in the range of 1 to 3; and
p is 1.

In another preferred embodiment, the acyl lactylate is selected from the group consisting of isostearyl lactylate, lauroyl lactylate, stearoyl lactylate, behenoyl lactylate, palmitoyl lactylate, palmitoyl-2-lactylate, stearoyl-2-lactylate, caproyl lactylate, oleyl lactylate, capryloyl lactate and myristoyl lactylate.

In another preferred embodiment, the cationic surfactants (A2) are selected from the group consisting of primary aliphatic amines, alkyl-substituted alkylenediamines, hydroxyalkyl-substituted alkylene diamines, quaternary ammonium compounds and salts thereof, fatty amido amine, 3-C₄-C₃₀ alkoxypropane-1 amines and salts thereof, N-(3-C₄-C₃₀ alkoxypropyl)-1,3-diaminopropane and salts thereof and condensation products of a saturated or unsaturated C₄-C₃₀ fatty acid and a polyalkylene polyamine.

In another preferred embodiment, the Z is selected from the cationic groups consisting of

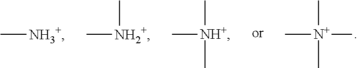

In another preferred embodiment, the cationic group may be present in a deprotonated form, depending on the pH.

In another preferred embodiment, the primary aliphatic amine is linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-cycloalkyl, linear or branched, substituted or unsubstituted C₄-C₃₀-heteroalkenyl and substituted or unsubstituted C₆-C₃₀-heterocycloalkyl; more preferably, linear or branched, substituted or unsubstituted C₈-C₂₂-alkyl, linear or branched, substituted or unsubstituted C₈-C₂₂-alkenyl, linear or branched, substituted or unsubstituted C₈-C₂₂-heteroalkyl, substituted or unsubstituted C₆-C₂₀-cycloalkyl, linear or branched, substituted or unsubstituted C₈-C₂₂-heteroalkenyl, and substituted or unsubstituted C₆-C₃₀-heterocycloalkyl; even more preferably, linear or branched, substituted or unsubstituted C₁₀-C₂₂-alkyl, linear or branched, substituted or unsubstituted C₁₀-C₂₂-alkenyl, linear or branched, substituted or unsubstituted C₁₀-C₂₂-heteroalkyl, substituted or unsubstituted C₆-C₁₆-cycloalkyl, linear or branched, substituted or unsubstituted C₁₀-C₂₂-heteroalkenyl and substituted or unsubstituted C₆-C₂₀-heterocycloalkyl; most preferably, linear or branched, substituted or unsubstituted C₁₀-C₂₀-alkyl, linear or branched, substituted or unsubstituted C₁₀-C₂₀-alkenyl, linear or branched, substituted or unsubstituted C₁₀-C₂₀-heteroalkyl, substituted or unsubstituted C₆-C₁₀-cycloalkyl, linear or branched, substituted or unsubstituted C₁₀-C₂₀-heteroalkenyl, and substituted or unsubstituted C₆-C₂₀-heterocycloalkyl; and in particular preferably, linear or branched C₁₂-C₁₈-alkyl, linear or branched, C₁₂-C₁₈-alkenyl, linear or branched C₁₂-C₁₈-heteroalkyl C₆-C₁₀-cycloalkyl, linear or branched C₁₂-C₁₈-heteroalkenyl and C₆-C₁₀-heterocycloalkyl; and even in particular preferably, linear or branched C₁₄-C₁₈-alkyl, linear or branched C₁₄-C₁₈-alkenyl, linear or branched, substituted or unsubstituted C₁₄-C₁₆-heteroalkyl, substituted or unsubstituted C₆-C₁₀-cycloalkyl, linear or branched, substituted or unsubstituted C₁₄-C₁₆-heteroalkenyl and substituted or unsubstituted C₆-C₁₀-heterocycloalkyl.

In another preferred embodiment, the primary aliphatic amines are selected from the group consisting of n-octylamine, n-decylamine, n-dodecylamine, n-tetradecylamine, n-hexadecylamine, n-octadecylamine, n-eicosylamine, n-docosylamine, n-hexadecenylamine and n-octadecenylamine.

In another preferred embodiment, the alkyl-substituted alkylenediamines is a compound of formula (A2a)

R⁶CHR⁷—NH—(CH₂)ₙNR⁴R⁵ formula (A2a)

wherein R⁶ and R⁷ are independent of each other selected from the group consisting of linear or branched, substituted or unsubstituted C₄-C₃₀-alkyl, linear or branched, substituted or unsubstituted C₄-C₃₀-alkenyl, R⁴ and R⁵ are independent of each other selected from the group consisting of hydrogen, linear or branched, substituted or unsubstituted C₁-Cₘ-alkyl, linear or branched, substituted or unsubstituted C₂-C₃₀-alkenyl, and in which n=2, 3 or 4; more preferably R⁶ and R⁷ are independently of each other are selected from the group consisting of linear or branched C₄-C₃₀-alkyl, linear or branched C₄-C₃₀-alkenyl, R⁴ and R⁵ are independent of each other selected from the group consisting of hydrogen, linear or branched, substituted or unsubstituted C₁-C₂₀-alkyl, linear or branched, substituted or unsubstituted C₂-C₂₀-alkenyl and in which n=2, 3 or 4, even more preferably, R⁶ and R⁷ are independently of each other are selected from the group consisting of linear or branched C₈-C₂₄-alkyl, linear or branched C₈-C₂₄-alkenyl, R⁴ and R⁵ are independent of each other selected from the group consisting of hydrogen, linear or branched, substituted or unsubstituted C₁-C₁₀-alkyl, linear or branched, substituted or unsubstituted C₂-C₁₀-alkenyl and in which n=2, 3 or 4; most preferably, R⁶ and R⁷ are independently of each other are selected from the group consisting of linear or branched C₁₂-C₂₀-alkyl, linear or branched C₁₂-C₂₀-alkenyl, R⁴ and R⁵ are independent of each other selected from the group consisting of hydrogen, linear or branched, substituted or unsubstituted C₁-C₆-alkyl, linear or branched, substituted or unsubstituted C₂-C₆-alkenyl and in which n=2, 3 or 4 and in particular preferably, R⁶ and R⁷ are independently of each other are selected from the group consisting of linear or branched C₁₄-C₁₈-alkyl, linear or branched C₁₄-C₁₈-alkenyl, R⁴ and R⁵ are independent of each other selected from the group consisting of hydrogen, linear or branched, substituted or unsubstituted C₁-C₄-alkyl, linear or branched, substituted or unsubstituted C₂-C₆-alkenyl and in which n=2, 3 or 4.

In another preferred embodiment, the hydroxyalkyl-substituted alkylenediamines is a compound of formula (A2b)

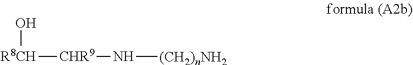

wherein R⁸ and R⁹ are independent of each other selected from the group consisting of hydrogen, linear or branched, substituted or unsubstituted C₄-C₃₀-alkyl, linear or branched, substituted or unsubstituted C₄-C₃₀-alkenyl and in which n=2, 3 or 4 with a provision such that R⁸+R⁹ is in the range of 8 to 32. More preferably R⁸ and R⁹ are independent of each other selected from the group consisting of linear or branched C₄-C₃₀-alkyl, linear or branched C₄-C₃₀-alkenyl and in which n=2, 3 or 4 with a provision such that R⁸+R⁹ is in the range of 8 to 32, even more preferably, R⁸ and R⁹ are independent of each other selected from the group consisting of linear or branched C₈-C₂₄-alkyl, linear or branched C₈-C₂₄-alkenyl and in which n=2, 3 or 4 with a provision such that R⁸+R⁹ is in the range of 9 to 25; most preferably, R⁸ and R⁹ are independent of each other selected from the group consisting of linear or branched C₁₂-C₂₀-alkyl, linear or branched C₁₂-C₂₀-alkenyl and in which n=2, 3 or 4 with a provision such that R⁸+R⁹ is in the range of 9 to 22, and in particular preferably, R⁸ and R⁹ are independent of each other selected from the group consisting of linear or branched C₁₄-C₁₈-alkyl, linear or branched C₁₄-C₁₈-alkenyl and in which n=2, 3 or 4 with a provision such that R⁸+R⁹ is in the range of 10 to 18.

In another preferred embodiment, the quaternary ammonium compound and salts thereof is a compound of formula (A2c)

[R¹⁰R¹¹R¹²R¹³N⁺]X⁻ formula (A2c)

wherein R¹⁰, R¹¹, R¹² and R¹³ are independent of each other selected from the group consisting of hydrogen, linear or branched, substituted or unsubstituted C₁-C₃₀-alkyl, linear or branched, substituted or unsubstituted C₂-C₃₀-alkenyl, and X is a halide anion, preferably a chloride ion.

In another preferred embodiment, in the quaternary ammonium compound (A2c) and salts thereof, the R¹⁰ is linear or branched, substituted or unsubstituted C₈-C₃₀-alkyl; R¹¹, R¹² and R¹³ are independent of each other selected from the group consisting of hydrogen, methyl and ethyl groups; and X is a chloride ion; more preferably R¹⁰ is linear or branched, substituted or unsubstituted C₈-C₂₄-alkyl; R¹¹, R¹² and R¹³ are independent of each other selected from the group consisting of hydrogen, methyl and ethyl groups; and X is a chloride ion; most preferably R¹⁰ is linear or branched, substituted or unsubstituted C₁₀-C₂₀-alkyl; R¹¹, R¹² and R¹³ are independent of each other selected from the group consisting of hydrogen and methyl groups; and X is a chloride ion; and in particular preferably R¹⁰ is linear or branched, substituted or unsubstituted C₁₂-C₁₈-alkyl; R¹¹, R¹² and R¹³ are independent of each other selected from the group consisting of hydrogen and methyl groups; and X is a chloride ion.

In another preferred embodiment, the cationic surfactants (A2) is 3-C₄-C₃₀ alkoxypropane-1-amine of formula (A2d) and salts thereof

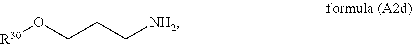

wherein R³⁰ is selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-cycloalkyl, linear or branched, substituted or unsubstituted C₄-C₃₀-heteroalkenyl and substituted or unsubstituted C₆-C₃₀-heterocycloalkyl; more preferably, linear or branched, substituted or unsubstituted C₈-C₂₂-alkyl, linear or branched, substituted or unsubstituted C₈-C₂₂-alkenyl, linear or branched, substituted or unsubstituted C₈-C₂₂-heteroalkyl, substituted or unsubstituted C₆-C₂₀-cycloalkyl, linear or branched, substituted or unsubstituted C₈-C₂₂-heteroalkenyl, and substituted or unsubstituted C₆-C₃₀-heterocycloalkyl; even more preferably, linear or branched, substituted or unsubstituted C₁₀-C₂₂-alkyl, linear or branched, substituted or unsubstituted C₁₀-C₂₂-alkenyl, linear or branched, substituted or unsubstituted C₁₀-C₂₂-heteroalkyl, substituted or unsubstituted C₆-C₁₆-cycloalkyl, linear or branched, substituted or unsubstituted C₁₀-C₂₂-heteroalkenyl and substituted or unsubstituted C₆-C₂₀-heterocycloalkyl; most preferably, linear or branched, substituted or unsubstituted C₁₀-C₂₀-alkyl, linear or branched, substituted or unsubstituted C₁₀-C₂₀-alkenyl, linear or branched, substituted or unsubstituted C₁₀-C₂₀-heteroalkyl, substituted or unsubstituted C₆-C₁₀-cycloalkyl, linear or branched, substituted or unsubstituted C₁₀-C₂₀-heteroalkenyl, and substituted or unsubstituted C₆-C₂₀-heterocycloalkyl; and in particular preferably, linear or branched C₁₂-C₁₈-alkyl, linear or branched, C₁₂-C₁₈-alkenyl, linear or branched C₁₂-C₁₈-heteroalkyl C₆-C₁₀-cycloalkyl, linear or branched C₁₂-C₁₈-heteroalkenyl and C₆-C₁₀-heterocycloalkyl; and even in particular preferably, linear or branched C₁₄-C₁₈-alkyl, linear or branched C₁₄-C₁₈-alkenyl, linear or branched, substituted or unsubstituted C₁₄-C₁₆-heteroalkyl, substituted or unsubstituted C₆-C₁₀-cycloalkyl, linear or branched, substituted or unsubstituted C₁₄-C₁₆-heteroalkenyl and substituted or unsubstituted C₆-C₁₀-heterocycloalkyl.

In another preferred embodiment, the cationic surfactants (A2) is 3-C₄-C₃₀ alkoxypropane-1-amine of formula (A2e) and salts thereof

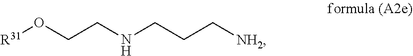

wherein R³¹ is selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-cycloalkyl, linear or branched, substituted or unsubstituted C₄-C₃₀-heteroalkenyl and substituted or unsubstituted C₆-C₃₀-heterocycloalkyl; more preferably, linear or branched, substituted or unsubstituted C₈-C₂₂-alkyl, linear or branched, substituted or unsubstituted C₈-C₂₂-alkenyl, linear or branched, substituted or unsubstituted C₈-C₂₂-heteroalkyl, substituted or unsubstituted C₆-C₂₀-cycloalkyl, linear or branched, substituted or unsubstituted C₈-C₂₂-heteroalkenyl, and substituted or unsubstituted C₆-C₃₀-heterocycloalkyl; even more preferably, linear or branched, substituted or unsubstituted C₁₀-C₂₂-alkyl, linear or branched, substituted or unsubstituted C₁₀-C₂₂-alkenyl, linear or branched, substituted or unsubstituted C₁₀-C₂₂-heteroalkyl, substituted or unsubstituted C₆-C₁₆-cycloalkyl, linear or branched, substituted or unsubstituted C₁₀-C₂₂-heteroalkenyl and substituted or unsubstituted C₆-C₂₀-heterocycloalkyl; most preferably, linear or branched, substituted or unsubstituted C₁₀-C₂₀-alkyl, linear or branched, substituted or unsubstituted C₁₀-C₂₀-alkenyl, linear or branched, substituted or unsubstituted C₁₀-C₂₀-heteroalkyl, substituted or unsubstituted C₆-C₁₀-cycloalkyl, linear or branched, substituted or unsubstituted C₁₀-C₂₀-heteroalkenyl, and substituted or unsubstituted C₆-C₂₀-heterocycloalkyl; and in particular preferably, linear or branched C₁₂-C₁₈-alkyl, linear or branched, C₁₂-C₁₈-alkenyl, linear or branched C₁₂-C₁₈-heteroalkyl C₆-C₁₀-cycloalkyl, linear or branched C₁₂-C₁₈-heteroalkenyl and C₆-C₁₀-heterocycloalkyl; and even in particular preferably, linear or branched C₁₄-C₁₈-alkyl, linear or branched C₁₄-C₁₈-alkenyl, linear or branched, substituted or unsubstituted C₁₄-C₁₆-heteroalkyl, substituted or unsubstituted C₆-C₁₀-cycloalkyl, linear or branched, substituted or unsubstituted C₁₄-C₁₆-heteroalkenyl and substituted or unsubstituted C₆-C₁₀-heterocycloalkyl.

In another preferred embodiment, the cationic surfactants (A2) is a condensation product of a saturated or unsaturated C₄-C₃₀ fatty acid and a polyalkylene polyamine; preferably, is a condensation product of a saturated or unsaturated C₈-C₂₄ fatty acid and a polyalkylene polyamine; more preferably, is a condensation product of a saturated or unsaturated C₁₀-C₂₀ fatty acid and a polyalkylene polyamine; most preferably, is a condensation product of a saturated or unsaturated C₁₂-C₂₀ fatty acid and a polyalkylene polyamine and in particular preferably, is a condensation product of a saturated or unsaturated C₁₂-C₁₈ fatty acid and a polyalkylene polyamine.

In another preferred embodiment, the polyalkylene polyamine is selected from the group consisting of triethylene tetraamine, N¹,N^{1′}-(ethane-1,2-diyl)bis(propane-1,3-diamine), trimethylene diamine, hexamethylene diamine, octamethylene diamine, di(heptamethylene)triamine, tripropylene tetraamine, tetraethylene pentaamine, trimethylene diamine, pentamethylene hexamine and di(trimethylene)triamine.

In another preferred embodiment, the condensation product of a saturated or unsaturated C₄-C₃₀ fatty acid and a polyalkylene polyamine is a condensation product of a saturated or unsaturated C₄-C₃₀ fatty acid and a triethylene tetraamine; more preferably, a condensation product of a saturated or unsaturated C₈-C₂₄ fatty acid and a triethylene tetraamine; even more preferably, a condensation product of a saturated or unsaturated C₁₂-C₂₂ fatty acid and a triethylene tetraamine; most preferably, a condensation product of a saturated or unsaturated C₁₄-C₂₀ fatty acid and a triethylene tetraamine; and in particular preferably, a condensation product of a saturated or unsaturated C₁₆-C₁₈ fatty acid and a triethylene tetraamine.

In another preferred embodiment, the condensation product of a saturated or unsaturated C₄-C₃₀ fatty acid and a polyalkylene polyamine is a condensation product of a saturated or unsaturated C₄-C₃₀ fatty acid and a N¹,N^{1′}-(ethane-1,2-diyl)bis(propane-1,3-diamine); more preferably, a condensation product of a saturated or unsaturated C₈-C₂₄ fatty acid and a N¹,N^{1′}-(ethane-1,2-diyl)bis(propane-1,3-diamine); even more preferably, a condensation product of a saturated or unsaturated C₁₂-C₂₂ fatty acid and a N¹,N^{1′}-(ethane-1,2-diyl)bis(propane-1,3-diamine); most preferably, a condensation product of a saturated or unsaturated C₁₄-C₂₀ fatty acid and a N¹,N^{1′}-(ethane-1,2-diyl)bis(propane-1,3-diamine); and in particular preferably, a condensation product of a saturated or unsaturated C₁₆-C₁₈ fatty acid and a N¹,N^{1′}-(ethane-1,2-diyl)bis(propane-1,3-diamine).

In another preferred embodiment, the condensation product of a saturated or unsaturated C₄-C₃₀ fatty acid and a polyalkylene polyamine is a condensation product of a saturated or unsaturated C₄-C₃₀ fatty acid and a hexamethylene diamine; more preferably, a condensation product of a saturated or unsaturated C₈-C₂₄ fatty acid and a hexamethylene diamine; even more preferably, a condensation product of a saturated or unsaturated C₁₂-C₂₂ fatty acid and a hexamethylene diamine; most preferably, a condensation product of a saturated or unsaturated C₁₄-C₂₀ fatty acid and a hexamethylene diamine; and in particular preferably, a condensation product of a saturated or unsaturated C₁₆-C₁₈ fatty acid and a hexamethylene diamine.

In another preferred embodiment, the cationic surfactants (A2) is fatty amido amine, of formula (A2f) and salts thereof

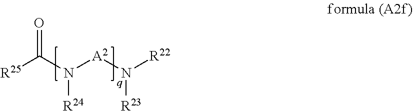

wherein R²⁵ is selected from the group consisting of linear or branched, substituted or unsubstituted C₄-C₃₀-alkyl, linear or branched, substituted or unsubstituted C₄-C₃₀-alkenyl; R²² and R²³ each independently, are selected from the group consisting of linear or branched, substituted or unsubstituted C₁-C₆-alkyl, linear or branched, substituted or unsubstituted C₂-C₆-alkenyl;
R²⁴ is selected from the group consisting of linear or branched, substituted or unsubstituted C₁-C₆-alkyl, linear or branched, substituted or unsubstituted C₂-C₆-alkenyl;
A² is an alkylene group having C₁-C₆ carbon atoms, and
q is 1, 2, 3 or 4.

In another preferred embodiment, the ampholytic surfactants (A3) are selected from compounds which contain at least one anionic group and at least one cationic group in the molecule. The anionic group is selected from carboxylate, sulfonate and phosphonate groups and the cationic group is elected from, primary amino group, secondary amino group, tertiary amino group and quaternary ammonium group.

In another preferred embodiment, the ampholytic surfactant is selected from the group consisting of N-substituted sarcosines, taurides, betaines, N-substituted aminopropionic acids and N-(1,2-dicarboxyethyl)-N-alkylsulfosuccinamates or compounds of the formula (A3a)

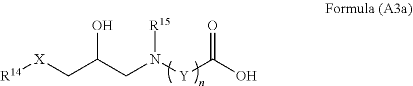

wherein R¹⁴ is selected from the group consisting of linear or branched, substituted or unsubstituted C₁-C₃₀-alkyl, linear or branched, substituted or unsubstituted C₂-C₃₀-alkenyl, R¹⁵ is selected from the group consisting of hydrogen, linear or branched, substituted or unsubstituted C₁-C₃₀-alkyl, linear or branched, substituted or unsubstituted C₂-C₃₀-alkenyl, X, Y=independent of each other selected from the group consisting of CH₂, NH or O; and n is an integer in the range of 0 to 6; more preferably, R¹⁴ is selected from the group consisting of linear or branched, substituted or unsubstituted C₄-C₃₀-alkyl, linear or branched, substituted or unsubstituted C₆-C₂₄-alkenyl, R¹⁵ is selected from the group consisting of hydrogen, linear or branched, substituted or unsubstituted C₁-C₂₀-alkyl, linear or branched, substituted or unsubstituted C₂-C₃₀-alkenyl, X, Y=independent of each other selected from the group consisting of CH₂, NH or O; and n is an integer in the range of 0 to 6; even more preferably, R¹⁴ is selected from the group consisting of linear or branched, substituted or unsubstituted C₁₀-C₂₂-alkyl, linear or branched, substituted or unsubstituted C₁₀-C₂₂-alkenyl, R¹⁵ is selected from the group consisting of hydrogen, linear or branched, substituted or unsubstituted C₁-C₁₀-alkyl, linear or branched, substituted or unsubstituted C₂-C₁₀-alkenyl, X, Y=independent of each other selected from the group consisting of CH₂, NH or O; and n is an integer in the range of 0 to 6; most preferably, R¹⁴ is selected from the group consisting of linear or branched, substituted or unsubstituted C₁₂-C₂₀-alkyl, linear or branched, substituted or unsubstituted C₁₂-C₂₀-alkenyl, R¹⁵ is selected from the group consisting of hydrogen, linear or branched, substituted or unsubstituted C₁-C₆-alkyl, linear or branched, substituted or unsubstituted C₂-C₆-alkenyl, X, Y=independent of each other selected from the group consisting of CH₂, NH or O; and n is an integer in the range of 0 to 6; and in particular preferably, R¹⁴ is selected from the group consisting of linear or branched, substituted or unsubstituted C₁₄-C₁₈-alkyl, linear or branched, substituted or unsubstituted C₁₄-C₁₈-alkenyl, R¹⁵ is selected from the group consisting of hydrogen, linear or branched, substituted or unsubstituted C₁-C₄-alkyl, linear or branched, substituted or unsubstituted C₂-C₄-alkenyl, X, Y=independent of each other selected from the group consisting of CH₂, NH or O; and n is an integer in the range of 0 to 6.

In another preferred embodiment, the N-substituted sarcosine is a compound of formula (A3b)

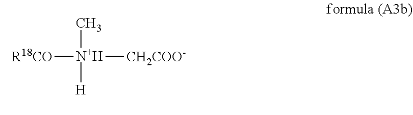

wherein R¹⁸ is selected from the group consisting of linear or branched, substituted or unsubstituted C₄-C₃₀-alkyl, linear or branched, substituted or unsubstituted C₂-C₃₀-alkenyl; more preferably, R¹⁸ is selected from the group consisting of linear or branched, substituted or unsubstituted C₈-C₂₄-alkyl, linear or branched, substituted or unsubstituted C₈-C₂₄-alkenyl; even more preferably, R¹⁸ is selected from the group consisting of linear or branched, substituted or unsubstituted C₁₀-C₂₂-alkyl, linear or branched, substituted or unsubstituted C₁₀-C₂₂-alkenyl; most preferably, R¹⁸ is selected from the group consisting of linear or branched, substituted or unsubstituted C₁₂-C₂₀-alkyl, linear or branched, substituted or unsubstituted C₁₂-C₂₀-alkenyl; and in particular most preferably, R¹⁸ is selected from the group consisting of linear or branched, substituted or unsubstituted C₁₆-C₁₈-alkyl, linear or branched, substituted or unsubstituted C₁₆-C₁₈-alkenyl.

In another preferred embodiment, the taurides is a compound of formula (A3c)

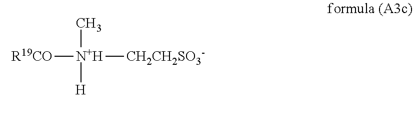

wherein R¹⁹ is selected from the group consisting of linear or branched, substituted or unsubstituted C₄-C₃₀-alkyl, linear or branched, substituted or unsubstituted C₂-C₃₀-alkenyl; more preferably, R¹⁹ is selected from the group consisting of linear or branched, substituted or unsubstituted C₈-C₂₄-alkyl, linear or branched, substituted or unsubstituted C₈-C₂₄-alkenyl; even more preferably, R¹⁹ is selected from the group consisting of linear or branched, substituted or unsubstituted C₁₀-C₂₂-alkyl, linear or branched, substituted or unsubstituted C₁₀-C₂₂-alkenyl; most preferably, R¹⁹ is selected from the group consisting of linear or branched, substituted or unsubstituted C₁₂-C₂₀-alkyl, linear or branched, substituted or unsubstituted C₁₂-C₂₀-alkenyl; and in particular most preferably, R¹⁹ is selected from the group consisting of linear or branched, substituted or unsubstituted C₁₆-C₁₈-alkyl, linear or branched, substituted or unsubstituted C₁₆-C₁₈-alkenyl.

In another preferred embodiment, the N-substituted aminopropionic acid is a compound of formula (A3d)

R²⁰(NHCH₂CH₂)ₙN⁺H₂CH₂CH₂C₀₀⁻ formula (A3d)

wherein R²⁰ is selected from the group consisting of linear or branched, substituted or unsubstituted C₄-C₃₀-alkyl, linear or branched, substituted or unsubstituted C₂-C₃₀-alkenyl, linear or branched, substituted or unsubstituted C₄-C₃₀-acyl and n is an integer in the range of 0 to 4; more preferably, R²⁰ is selected from the group consisting of linear or branched, substituted or unsubstituted C₈-C₂₄-alkyl, linear or branched, substituted or unsubstituted C₈-C₂₄-alkenyl, linear or branched, substituted or unsubstituted C₈-C₂₄-acyl and n is an integer in the range of 0 to 4; even more preferably, R²⁰ is selected from the group consisting of linear or branched, substituted or unsubstituted C₁₀-C₂₂-alkyl, linear or branched, substituted or unsubstituted C₁₀-C₂₂-alkenyl, linear or branched, substituted or unsubstituted C₁₀-C₂₂-acyl and n is an integer in the range of 0 to 4; most preferably, R²⁰ is selected from the group consisting of linear or branched, substituted or unsubstituted C₁₂-C₂₀-alkyl, linear or branched, substituted or unsubstituted C₁₂-C₂₀-alkenyl, linear or branched, substituted or unsubstituted C₁₂-C₂₀-acyl and n is an integer in the range of 0 to 4; and in particular most preferably, R²⁰ is selected from the group consisting of linear or branched, substituted or unsubstituted C₁₆-C₁₈-alkyl, linear or branched, substituted or unsubstituted C₁₆-C₁₈-alkenyl, linear or branched, substituted or unsubstituted C₁₆-C₁₈-acyl and n is an integer in the range of 0 to 4.

In another preferred embodiment, the N-(1,2-dicarboxyethyl)-N-alkylsulfosuccinamates acid is a compound of formula (A3e)

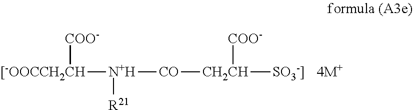

wherein R²¹ is selected from the group consisting of linear or branched, substituted or unsubstituted C₄-C₃₀-alkyl, linear or branched, substituted or unsubstituted C₂-C₃₀-alkenyl and M is selected from the group consisting of hydrogen ion, an alkali metal cation or an ammonium ion; more preferably, R²¹ is selected from the group consisting of linear or branched, substituted or unsubstituted C₈-C₂₄-alkyl, linear or branched, substituted or unsubstituted C₈-C₂₄-alkenyl and M is selected from the group consisting of hydrogen ion, an alkali metal cation or an ammonium ion; even more preferably, R²¹ is selected from the group consisting of linear or branched, substituted or unsubstituted C₁₀-C₂₂-alkyl, linear or branched, substituted or unsubstituted C₁₀-C₂₂-alkenyl and M is selected from the group consisting of hydrogen ion, an alkali metal cation or an ammonium ion; most preferably, R²¹ is selected from the group consisting of linear or branched, substituted or unsubstituted C₁₂-C₂₀-alkyl, linear or branched, substituted or unsubstituted C₁₂-C₂₀-alkenyl and M is selected from the group consisting of hydrogen ion, an alkali metal cation or an ammonium ion; and in particular most preferably, R²¹ is selected from the group consisting of linear or branched, substituted or unsubstituted C₁₆-C₁₈-alkyl, linear or branched, substituted or unsubstituted C₁₆-C₁₈-alkenyl and M is selected from the group consisting of hydrogen ion, an alkali metal cation or an ammonium ion.

In another preferred embodiment, the betaine is a compound of formula (A3f)

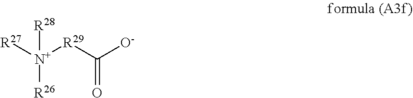

wherein R²⁶ is selected from the group consisting of linear or branched, substituted or unsubstituted C₄-C₃₀-alkyl, linear or branched, substituted or unsubstituted C₂-C₃₀-alkenyl; R²⁷ and R²⁸ each independently, are selected from the group consisting of hydrogen, linear or branched, substituted or unsubstituted C₁-C₆-alkyl, linear or branched, substituted or unsubstituted C₂-C₆-alkenyl; and R²⁹ is an alkylene group having C₁-C₆ carbon atoms.

In another preferred embodiment, the non-ionic surfactants (A4) are selected from alkoxylated branched or linear C₆-C₁₈ alcohols, branched or linear C₆-C₁₈ alcohols, kerosene, transformer oils and synthetic hydrocarbon oils.

In another preferred embodiment, the alkoxylated branched or linear C₆-C₁₈ alcohol is a compound of formula (A4a)

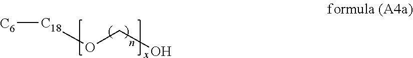

wherein n is an integer in the range of 1 to 4 and x is an integer in the range of 0.1 to 30; more preferably n is an integer in the range of 2 to 4 and x is an integer in the range of 0.5 to 25; most preferably n is 2 and x is an integer in the range of 1 to 20; and in particular preferably n is 2 and x is an integer in the range of 2 to 15.

In another preferred embodiment, the alkoxylated branched or linear C₆-C₁₈ alcohol is a compound of formula (A4b) or a compound of formula (A4c)

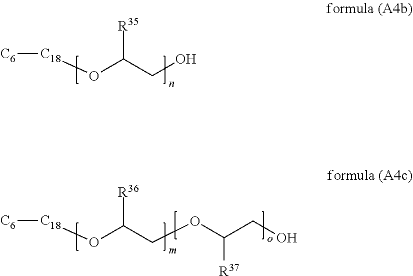

wherein R³⁵, R³⁶ and R³⁷ independent of each other are selected from the group consisting of hydrogen, methyl, ethyl, propyl, isopropyl, n-butyl, isobutyl and tert-butyl, n is an integer in the range of 1 to 40; m is an integer in the range of 0 to 40 and o is an integer in the range of 1 to 40; preferably, R³⁵, R³⁶ and R³⁷ independent of each other are selected from the group consisting of hydrogen, methyl, ethyl, propyl, isopropyl and n-butyl, n is an integer in the range of 5 to 40; m is an integer in the range of 5 to 40 and o is an integer in the range of 5 to 40; more preferably, R³⁵, R³⁶ and R³⁷ independent of each other are selected from the group consisting of hydrogen, methyl, ethyl and propyl, n is an integer in the range of 5 to 40; m is an integer in the range of 5 to 40 and o is an integer in the range of 5 to 40; even more preferably, R³⁵, R³⁶ and R³⁷ independent of each other are selected from the group consisting of hydrogen, methyl, ethyl and propyl, n is an integer in the range of 5 to 30; m is an integer in the range of 5 to 30 and o is an integer in the range of 5 to 30; most preferably, R³⁵, R³⁶ and R³⁷ independent of each other are selected from the group consisting of hydrogen, methyl and ethyl, n is an integer in the range of 5 to 30; m is an integer in the range of 5 to 30 and o is an integer in the range of 5 to 30; and in particular, R³⁵, R³⁶ and R³⁷ independent of each other are selected from the group consisting of hydrogen and methyl, n is an integer in the range of 5 to 30; m is an integer in the range of 5 to 30 and o is an integer in the range of 5 to 30;

In another preferred embodiment, the alkoxylated branched or linear C₆-C₁₈ alcohol is ethoxylated and/or propoxylated isotridecanol with a degree of branching between 1 and 3.

In another preferred embodiment, the at least one component (B) comprises a polymer selected from the group consisting of alkoxylated polyalkyleneimine (B1) and alkoxylated hexamethylene diamine (B2); more preferably the component (B) comprises a polymer selected from the group consisting of alkoxylated polyalkyleneimine (B1).

In another preferred embodiment, the alkoxylated polyalkyleneimine (B1) is a compound of formula (B1)

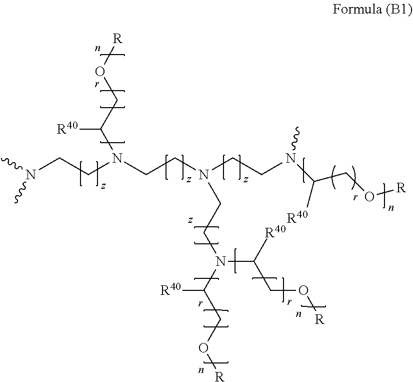

wherein R and R⁴⁰ are independently of each other selected from the group consisting of hydrogen, methyl, ethyl, propyl, isopropyl, butyl, isobutyl and t-butyl; and n is an integer in the range of 1 to 100, r is an integer in the range of 1 to 4, z is an integer is in the range of 1 to 4; more preferably, R and R⁴⁰ are independently of each other selected from the group consisting of hydrogen, methyl, ethyl, propyl and isopropyl; and n is an integer in the range of 1 to 50, r is an integer in the range of 1 to 3, z is an integer is in the range of 1 to 3; even more preferably, R and R⁴⁰ are independently of each other selected from the group consisting of hydrogen, methyl and ethyl; and n is an integer in the range of 5 to 30, r is an integer in the range of 1 to 2, z is an integer is in the range of 1 to 2; most preferably, R and R⁴⁰ are independently of each other selected from the group consisting of hydrogen and methyl; and n is an integer in the range of 5 to 20, r is an integer in the range of 1 to 2, z is an integer is in the range of 1 to 2; and in particular preferably, R and R⁴⁰ are independently of each other selected from the group consisting of hydrogen; and n is an integer in the range of 5 to 15, r is 1, z is 1.

In another preferred embodiment, the alkoxylated polyalkyleneimine (B1) is a compound of formula (B1a) or a compound of formula (B1b)

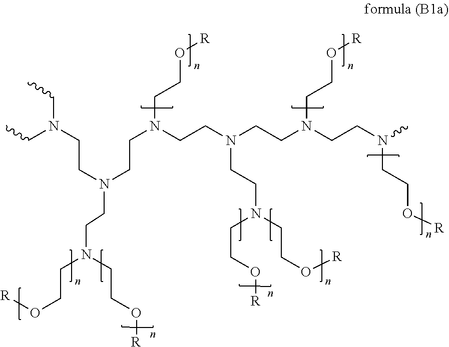

wherein R is selected from the group consisting of hydrogen, methyl, ethyl, propyl, isopropyl, butyl, isobutyl and t-butyl; and n is an integer in the range of 1 to 100; more preferably, R is selected from the group consisting of hydrogen, methyl, ethyl, propyl and isopropyl; and n is an integer in the range of 1 to 50; even more preferably, R is selected from the group consisting of hydrogen, methyl and ethyl; and n is an integer in the range of 5 to 30; most preferably, R is selected from the group consisting of hydrogen and methyl; and n is an integer in the range of 5 to 20; and in particular preferably, R is selected from the group consisting of hydrogen; and n is an integer in the range of 5 to 15;

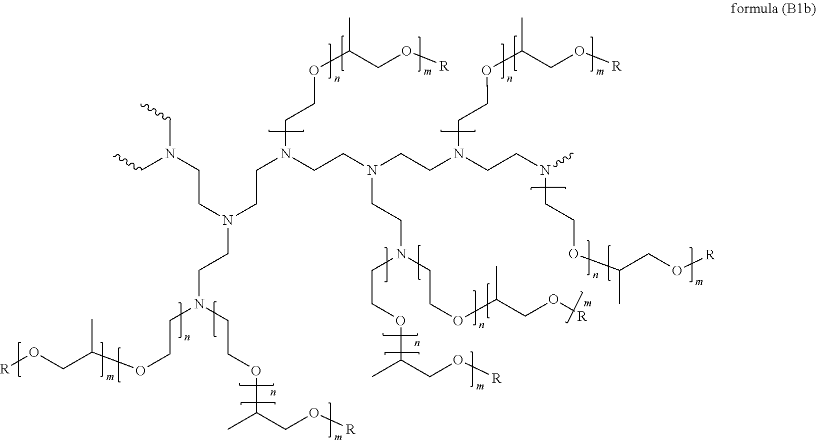

wherein R is selected from the group consisting of hydrogen, methyl, ethyl, propyl, isopropyl, butyl, isobutyl and t-butyl; n is an integer in the range of 1 to 100 and m is an integer in the range of 1 to 100; more preferably, R is selected from the group consisting of hydrogen, methyl, ethyl, propyl and isopropyl; n is an integer in the range of 1 to 50 and m is an integer in the range of 1 to 50; even more preferably, R is selected from the group consisting of hydrogen, methyl and ethyl; n is an integer in the range of 5 to 30 and m is an integer in the range of 1 to 30; most preferably, R is selected from the group consisting of hydrogen and methyl; n is an integer in the range of 5 to 20 and m is an integer in the range of 1 to 20; and in particular preferably, R is selected from the group consisting of hydrogen; n is an integer in the range of 5 to 15 and n is an integer in the range of 1 to 10.

In another preferred embodiment, the alkoxylated polyalkyleneimine (B1) is a compound of formula (B1a).

In another preferred embodiment, when the alkoxylated polyalkyleneimine (B1) is a compound of formula (B1b), then the ratio of the ethoxy to the propoxy is in the range of 1.0:0.1 to 10:0.1.

In another preferred embodiment, the alkoxylated polyalkyleneimine (B1) is ethoxylated polyethyleneimine (B1a) having a weight average molecular weight Mw in the range from 3000 to 250,000 g/mol, as determined according to GPC, which has 80 to 99% by weight ethylene oxide side chains, based on total alkoxylated polyalkyleneimine; more preferably, the alkoxylated polyalkyleneimine (B1) is ethoxylated polyethyleneimine (B1a) having a weight average molecular weight Mw in the range from 3000 to 100,000 g/mol, as determined according to GPC, which has 80 to 99% by weight ethylene oxide side chains, based on total alkoxylated polyalkyleneimine; even more preferably, the alkoxylated polyalkyleneimine (B1) is ethoxylated polyethyleneimine (B1a) having a weight average molecular weight Mw in the range from 3000 to 50,000 g/mol, as determined according to GPC, which has 80 to 99% by weight ethylene oxide side chains, based on total alkoxylated polyalkyleneimine; most preferably, the alkoxylated polyalkyleneimine (B1) is ethoxylated polyethyleneimine (B1a) having a weight average molecular weight Mw in the range from 3500 to 30,000 g/mol, as determined according to GPC, which has 80 to 99% by weight ethylene oxide side chains, based on total alkoxylated polyalkyleneimine; and in particular preferably, the alkoxylated polyalkyleneimine (B1) is ethoxylated polyethyleneimine (B1a) having a weight average molecular weight Mw in the range from 3500 to 25,000 g/mol, as determined according to GPC, which has 80 to 99% by weight ethylene oxide side chains, based on total alkoxylated polyalkyleneimine.

In another preferred embodiment, the alkoxylated polyalkyleneimine (B1) is ethoxylated/propoxylated polyethyleneimine (B1b) having a weight average molecular weight Mw in the range from 3000 to 250,000 g/mol, as determined according to GPC, which has 80 to 99 by weight ethylene oxide side chains, based on total ethoxylated/propoxylated polyethyleneimine; more preferably, the alkoxylated polyalkyleneimine (B1) is ethoxylated/propoxylated polyethyleneimine (B1b) having a weight average molecular weight Mw in the range from 3000 to 100,000 g/mol, as determined according to GPC, which has 80 to 99 by weight ethylene oxide side chains, based on total ethoxylated/propoxylated polyethyleneimine; even more preferably, the the alkoxylated polyalkyleneimine (B1) is ethoxylated/propoxylated polyethyleneimine (B1b) having a weight average molecular weight Mw in the range from 3000 to 50,000 g/mol, as determined according to GPC, which has 80 to 99% by weight ethylene oxide side chains, based on total ethoxylated/propoxylated polyethyleneimine; most preferably, the alkoxylated polyalkyleneimine (B1) is ethoxylated/propoxylated polyethyleneimine (B1b) having a weight average molecular weight Mw in the range from 3500 to 30,000 g/mol, as determined according to GPC, which has 80 to 99% by weight ethylene oxide side chains, based on total ethoxylated/propoxylated polyethyleneimine; and in particular preferably, the alkoxylated polyalkyleneimine (B1) is ethoxylated/propoxylated polyethyleneimine (B1b) having a weight average molecular weight Mw in the range from 3500 to 25,000 g/mol, as determined according to GPC, which has 80 to 99% by weight ethylene oxide side chains, based on total ethoxylated/propoxylated polyethyleneimine.

In another preferred embodiment, the alkoxylated hexamethylene diamine (B2) has a weight average molecular weight Mw in the range from 2000 to 100,000 g/mol, as determined according to GPC; more preferably weight average molecular weight Mw in the range from 2000 to 50,000 g/mol, as determined according to GPC; even more preferably weight average molecular weight Mw in the range from 2000 to 20,000 g/mol, as determined according to GPC; most preferably weight average molecular weight Mw in the range from 2000 to 10,000 g/mol, as determined according to GPC; and in particular preferably weight average molecular weight Mw in the range from 3000 to 10,000 g/mol, as determined according to GPC.

In another preferred embodiment, the ratio of component (B) to the component (A) is in the range of 1.0:1000 to 10:1.0.

In another preferred embodiment, the composition comprises the at least one component (A) in an amount in the range from ≥10 wt. % to ≤99.9 wt. % and the at least one component (B) in an amount in the range from ≥0.1 wt. % to ≤90 wt. %, based on the total weight of the composition; more preferably, the composition comprises the at least one component A in an amount in the range of ≥50 wt. % to ≤90 wt. % and the at least one component B in an amount of ≥5 wt. % to ≤35 wt. %, based on the total weight of the collector composition; and most preferably the composition comprises the at least one component A in an amount in the range of ≥50 wt. % to ≤75 wt. % and the at least one component B in an amount of ≥15 wt. % to ≤35 wt. %, based on the total weight of the collector composition.

In another preferred embodiment, the composition comprises additives and/or modifier in an amount is in the range from 0% to 10%, preferably in the range from 0.2% to 8%, more preferably in the range from 0.4% to 6% and most preferably in the range from 0.5% to 5%.

In another preferred embodiment, the composition comprises a fatty acid amidoamine as a cationic collector (A4) and an ethoxylated polyethyleneimine with a weight average molecular weight of ˜13000, with ethoxylate side chains making up 95% of the polymer molecular weight.

In another preferred embodiment, the composition comprises a blend of fatty acid with nonionic and sulfonated anionic surfactants as an anionic collector (A1) ethoxylated polyethyleneimine with a weight average molecular weight of ˜13000, with ethoxylate side chains making up 95% of the polymer molecular weight.

In another preferred embodiment, the composition comprises distilled tall oil fatty acid (120 g/t ore), isotridecanol (45 g/t ore), ethoxylated branched isotridecanol (45 g/t ore) and ethoxylated polyethyleneimine (50 g/t ore to 150 g/t ore) with a weight average molecular weight of ˜13000, with ethoxylate side chains making up 95% of the polymer molecular weight.

In another preferred embodiment, the composition comprises a condensation product of distilled soybean oil fatty acid with triethylene tetraamine in a molar ratio 1:1 (75 g/t ore) and an ethoxylated polyethyleneimine (10 g/t ore to 100 g/t ore) with a weight average molecular weight of ˜13000, with ethoxylate side chains making up 95% of the polymer molecular weight.

In another preferred embodiment, the component (A) and the component (B) added together or separately to the flotation system.

In another preferred embodiment, the presently claimed invention is directed to a direct flotation process for the beneficiation of a mineral comprising the steps of:

a. comminution of ores,
b. optionally, conditioning of the ores with depressants and/or activators,
c. pH adjustment,
d. component (B) addition
e. component (A) addition,
f. flotation,
g. collection of the mineral in the froth,
wherein the components (A) and (B) are defined as above.

In another preferred embodiment, the presently claimed invention is directed to a reverse flotation process for the beneficiation of ores containing undesirable minerals (including friable silicates), by collection of undesirable minerals from the ore in the froth, comprising the steps of:

a. comminution of ores,
b. optionally, conditioning of the ores with depressants and/or activators,
c. pH adjustment,
d. component (B)
e. component (A) addition,
f. flotation,
g. collection of carbonate and/or silicate and/or other impurities in the froth,
h. recovering of the mineral,
wherein the components (A) and (B) are defined as above.

In another preferred embodiment, the direct flotation process and reverse flotation process comprises the step of adding one or more modifiers and/or one or more frothers before step d).

In another preferred embodiment, the overall amount of component (A) and component (B) composition is in the range of 10 g to 10 Kg per 1000 kg mineral.

In another preferred embodiment, the presently claimed invention is directed to a collector composition for the beneficiation of a mineral comprising:

A. at least one component (A),
B. at least one component (B), and
C. at least one frother (C),
wherein the at least one component (A) is selected from the group consisting of anionic surfactants (A1), cationic surfactants (A2), ampholytic surfactants (A3) and non-ionic surfactants (A4), and
   the at least one component (B) comprises a polymer selected from the group consisting of alkoxylated polyalkyleneimine (B1) and alkoxylated hexamethylene diamine (B2); more preferably, composition for the beneficiation of a mineral comprising:
   A. at least one component (A),
   B. at least one component (B), and
   C. at least one frother (C),
   wherein the at least one component (A) is selected from the group consisting of cationic surfactants (A2) and non-ionic surfactants (A4), and
      the at least one component (B) comprises a polymer selected from the group consisting of alkoxylated polyalkyleneimine (B1) and alkoxylated hexamethylene diamine (B2); and most preferably, composition for the beneficiation of a mineral comprising:
      A. at least one component (A),
      B. at least one component (B), and
      C. at least one frother (C),
wherein the at least one component (A) is selected from the group consisting of cationic surfactants (A2) and
   the at least one component (B) comprises a polymer selected from the group consisting of alkoxylated polyalkyleneimine (B1).

In another preferred embodiment, the presently claimed invention is directed to a collector composition for the beneficiation of a mineral comprising:
A. at least one component (A),
B. at least one component (B),
C. at least one frother (C), and
D. at least one modifier (D),
   wherein the at least one component (A) is selected from the group consisting of anionic surfactants (A1), cationic surfactants (A2), ampholytic surfactants (A3) and non-ionic surfactants (A4), and
   the at least one component (B) comprises a polymer selected from the group consisting of alkoxylated polyalkyleneimine (B1) and alkoxylated hexamethylene diamine (B2); more preferably, composition for the beneficiation of a mineral comprising:
A. at least one component (A),
B. at least one component (B), and
C. at least one frother (C), and
D. at least one modifier (D),
   wherein the at least one component (A) is selected from the group consisting of cationic surfactants (A2) and non-ionic surfactants (A4), and
      the at least one component (B) comprises a polymer selected from the group consisting of alkoxylated polyalkyleneimine (B1) and alkoxylated hexamethylene diamine (B2); and most preferably, composition for the beneficiation of a mineral comprising:
A. at least one component (A),
B. at least one component (B), and
C. at least one frother (C), and
D. at least one modifier (D),
   wherein the at least one component (A) is selected from the group consisting of cationic surfactants (A2) and
   the at least one component (B) comprises a polymer selected from the group consisting of alkoxylated polyalkyleneimine (B1).

In another preferred embodiment, the frother (C) is selected from the group consisting of pine oil, aliphatic C₅-C₈ alcohols, cresylic acids, polyglycols and polyglycol ethers.

In another preferred embodiment, the frother (C) is present in an amount in the range of ≥0 wt. % to ≤70 wt. %, based on the total weight of the collector composition; more preferably, the frother (C) present in an amount in the range of ≥0 wt. % to ≤50 wt. %, even more preferably, the frother (C) present in an amount in the range of ≥0 wt. % to ≤30 wt. %, most preferably the frother (C) present in an amount in the range of ≥5 wt. % to ≤20 wt. %, and in particular, the frother (C) present in an amount in the range of ≥5 wt. % to ≤10 wt. %, each based on the total weight of the collector composition.

In another preferred embodiment, the modifier (D) is also known as depressant.

In another preferred embodiment. the modifier (D) is selected from the group consisting of linseed Oil, quebracho, tannin, and acidified sodium dichromate. In another preferred embodiment, the modifier (D) is present in an amount in the range of ≥0 wt. % to ≤70 wt. %, based on the total weight of the collector composition; more preferably, the modifier (D) present in an amount in the range of ≥0 wt. % to ≤50 wt. %, even more preferably, the modifier (D) present in an amount in the range of ≥0 wt. % to ≤30 wt. %, most preferably the modifier (D) present in an amount in the range of ≥5 wt. % to ≤20 wt. %, and in particular, the modifier (D) present in an amount in the range of ≥5 wt. % to ≤10 wt. %, each based on the total weight of the collector composition.

The presently claimed invention is associated with at least one of the following advantages:

(i) A high-grade concentrate is obtained in good yield by using the collector composition according to the presently claimed invention in comparatively low amounts.
(ii) A high-grade concentrate is obtained in a high yield from a low-grade mineral by using the collector composition according to the presently claimed invention.
(iii) The collector composition according to presently claimed invention is suitable for the separation of ores containing silicate and iron impurities.
(iv) The collector composition according to presently claimed invention significantly reduced the quantity of silicate and iron impurities in the concentrate.

### Embodiments

In the following, there is provided a list of embodiments to further illustrate the present disclosure without intending to limit the disclosure to the specific embodiments listed below.
1. Use of a composition for the beneficiation of a mineral, wherein the composition comprises:
   A. at least one component (A), and
   B. at least one component (B),
   wherein the at least one component (A) is selected from the group consisting of anionic surfactants (A1), cationic surfactants (A2), ampholytic surfactants (A3) and non-ionic surfactants (A4), and
   the at least one component (B) comprises a polymer selected from the group consisting of alkoxylated polyalkyleneimine (B1) and alkoxylated hexamethylene diamine (B2).
2. The use according to embodiment 1, wherein the anionic surfactants (A1) are selected from compounds of formula (A1) or derivatives thereof,

[(G)ₘ(Z)ₙ]ₒ (A1),
wherein each G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, linear or branched, substituted or unsubstituted C₆-C₃₀-heterocycloalkyl and substituted or unsubstituted C₆-C₃₀-aralkyl;
each Z is independently selected from group consisting of

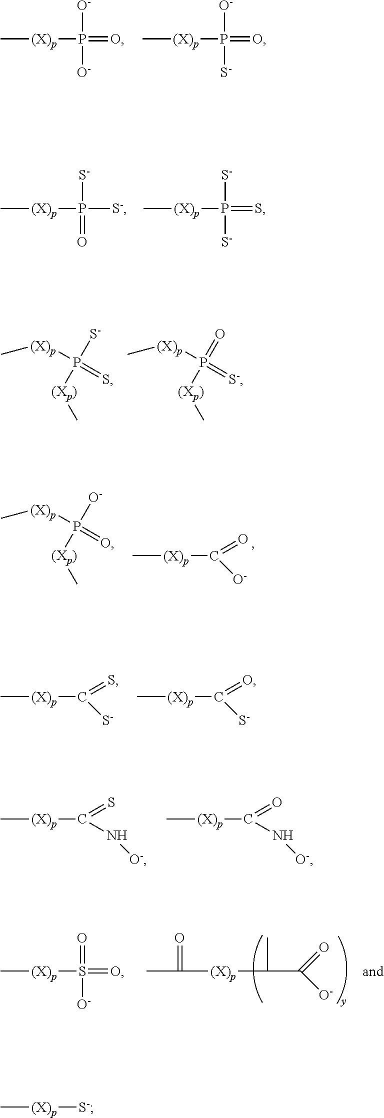

X is independently selected from the group consisting of O, S, NH and CH₂;
m is an integer in the range from 1 to 10;
n is an integer in the range from 1 to 10; and
is in the range from 1 to 100;
y is in the range of 1 to 10; and
p is 0, 1 or 2.
3. The use according to embodiment 1 or 2, wherein the anionic surfactants (A1) are selected from the group consisting of fatty acids, alkyl sulfates, alkyl sulfosuccinates, alkyl sulfosuccinamates, acyl sarcosides, N-acylaminoacids, alkyl benzene sulfonates, alkyl sulfonates, petroleum sulfonates, acyl lactylates and salts thereof.
4. The use according to embodiment 3, wherein the fatty acid is selected from the group consisting of saturated or unsaturated C₄-C₃₀ fatty acids and mixtures thereof, salts of saturated or unsaturated C₄-C₃₀ fatty acids and mixtures thereof, and condensation products of saturated or unsaturated C₄-C₃₀ fatty acids and mixtures thereof.
5. The use according to c embodiment 4, wherein the saturated or unsaturated C₄-C₃₀ fatty acids and mixtures thereof are selected from the group consisting of octanoic acid, nonanoic acid, decanoic acid, undecanoic acid, dodecanoic acid, tridecanoic acid, tetradecanoic acid, pentadecanoic acid, hexadecanoic acid, heptadecanoic acid, isostearic acid, octadecanoic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid and mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends and derivatives thereof.
6. The use according to embodiment 4, wherein the saturated or unsaturated C₄-C₃₀ fatty acids and mixtures thereof are selected from the group consisting of f tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends and derivatives thereof.
7. The use according to embodiment 1, wherein the cationic surfactants (A2) are selected from the group consisting of primary aliphatic amines, linear or branched polyethyleneimine, alkyl-substituted alkylenediamines, hydroxyalkyl-substituted alkylene diamines, quaternary ammonium compounds and salts thereof, 3-C₄-C₃₀ alkoxypropane-1amines and salts thereof, N-(3-C₄-C₃₀ alkoxypropyl)-1,3-diaminopropane and salts thereof, fatty amido amine and condensation products of a saturated or unsaturated C₄-C₃₀ fatty acid and a polyalkylene polyamine.
8. The use according to embodiment 7, wherein the polyalkylene polyamine is selected from the group consisting of triethylene tetraamine, N¹,N^{1′}-(ethane-1,2-diyl)bis(propane-1,3-diamine), trimethylene diamine, hexamethylene diamine, octamethylene diamine, di(heptamethylene)triamine, tripropylene tetraamine, tetraethylene pentaamine, trimethylene diamine, pentamethylene hexamine and di(trimethylene)triamine.
9. The use according to embodiment 1, wherein the ampholytic surfactants (A3) are selected from compounds which contain at least one anionic group and at least one cationic group in the molecule.
10. The use according to embodiment 9, wherein the compounds which contain at least one anionic and at least one cationic group in the molecule are selected from N-substituted sarcosides, taurides, betaines, N-substituted aminopropionic acids and N-(1,2-dicarboxyethyl)-N-alkylsulfosuccinamates or a compound of formula (A3a)

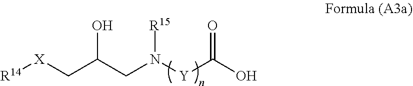

R¹⁴ is selected from the group consisting of linear or branched, substituted or unsubstituted C₁-C₃₀-alkyl, linear or branched, substituted or unsubstituted C₂-C₃₀-alkenyl, R¹⁵ is selected from the group consisting of hydrogen, linear or branched, substituted or unsubstituted C₁-C₃₀-alkyl, linear or branched, substituted or unsubstituted C₂-C₃₀-alkenyl, X, Y=independent of each other selected from the group consisting of CH₂, NH or O; and n is an integer in the range of 0 to 6.
11. The use according to embodiment 1, wherein the non-ionic surfactants (A4) are selected from linear or branched C₆-C₁₈ alcohols, alkoxylated linear or branched C₆-C₁₈ alcohols, kerosene, transformer oils and synthetic hydrocarbon oils.
12. The use according to embodiment 11, wherein the alkoxylated linear or branched C₆-C₁₈ alcohol has a degree of alkoxylation in the range of 0.1 to 30.
13. The use according to embodiments 11 to 12, wherein the alkoxylated linear or branched C₆-C₁₈ alcohol is ethoxylated and/or propoxylated isotridecanol with a degree of branching between 1 and 3.
14. The use according to embodiment 11, wherein the linear or branched C₆-C₁₈ alcohol is isotridecanol with a degree of branching between 1 and 3
15. The use according to embodiments 1 to 14, wherein the alkoxylated polyalkyleneimine (B1) has a weight average molecular weight Mw in the range from 3000 to 250,000 g/mol, as determined according to GPC, which has 80 to 99% by weight ethylene oxide side chains, based on total alkoxylated polyalkyleneimine (B1).
16. The use according to embodiments 1 to 14, wherein the alkoxylated hexamethylene diamine (B2) has a weight average molecular weight Mw in the range from 2000 to 100,000 g/mol, as determined according to GPC.
17. The use according to embodiments 1 to 16, wherein the at least one alkoxylated polyalkyleneimine (B1) is selected the group consisting of ethoxylated polyethylenimine (B1a) and propoxylated polyethyleneimine (B1b).
18. The use according to embodiments 1 to 17, wherein the amount of the at least one component (A) is in the range from ≥10 wt. % to ≤99.9 wt. %, based on the total weight of the composition.
19. The use according to embodiments 1 to 18, wherein the amount of the at least one component (B) is in the range from ≥0.1 wt. % to ≤90 wt. %, based on the total weight of the composition.
20. The use according to embodiments 1 to 19, wherein the composition comprises the at least one component (A) in an amount in the range from ≥10 wt. % to ≤99.9 wt. % and the at least one component (B) in an amount in the range from ≥0.1 wt. % to ≤90 wt. %, based on the total weight of the composition.
21. A direct flotation process for the beneficiation of a mineral comprising the steps of:
   a. comminution of ores,
   b. optionally, conditioning of the ores with depressants and/or activators,
   c. pH adjustment,
   d. component (B) addition
   e. component (A) addition,
   f. flotation,
   g. collection of the mineral in the froth,
   wherein the components (A) and (B) are as defined as in embodiments 1 to 20.
22. The direct flotation process according to embodiment 21, wherein the process comprises the step of adding one or more modifiers and/or one or more frothers before step d).
23. The direct flotation process according to embodiment 21 to 22, wherein the amount of the composition is in the range of 10 g to 10 Kg per 1000 kg mineral.
24. A reverse flotation process for the beneficiation of a mineral comprising the friable silicates by collection of undesired minerals from an ore in the froth, comprising the steps of:
   a. comminution of ores,
   b. optionally, conditioning of the ores with depressants and/or activators,
   c. pH adjustment,
   d. component (B) addition
   e. component (A) addition,
   f. flotation,
   g. collection of carbonate and/or silicate and/or other impurities in the froth,
   h. recovering of the mineral,
   wherein the components (A) and (B) are as defined as embodiments in 1 to 20.
25. The process according to embodiment 24, wherein the process comprises the step of adding one or more modifiers and/or one or more frothers before step d).
26. The reverse flotation process according to embodiments 24 to 25, wherein the amount of the composition is in the range of 10 g to 10 Kg per 1000 kg mineral.
27. A collector composition for the beneficiation of a mineral comprising:
   A. at least one component (A),
   B. at least one component (B), and
   C. at least one frother (C),
   wherein the at least one component (A) is selected from the group consisting of anionic (A1) surfactants, cationic (A2) surfactants, ampholytic (A3) surfactants and non-ionic surfactants (A4), and
   the at least one component (B) comprises a polymer selected from the group consisting of alkoxylated polyalkyleneimine (B1) and alkoxylated hexamethylene diamine (B2); wherein the amount of the at least one component (A) is in the range from ≥10 wt. % to ≤99.9 wt. %, based on the total weight of the composition and the amount of the at least one component (B) is in the range from ≥0.1 wt. % to ≤90 wt. %, based on the total weight of the composition.
28. A collector composition for the beneficiation of a mineral comprising:
   A. at least one component (A),
   B. at least one component (B),
   C. at least one frother (C), and
   D. at least one modifier (D),
   wherein the at least one component (A) is selected from the group consisting of anionic (A1) surfactants, cationic (A2) surfactants, ampholytic (A3) surfactants and non-ionic surfactants (A4), and
   the at least one component (B) comprises a polymer selected from the group consisting of alkoxylated polyalkyleneimine (B1) and alkoxylated hexamethylene diamine (B2); wherein the amount of the at least one component (A) is in the range from ≥10 wt. % to ≤99.9 wt. %, based on the total weight of the composition and the amount of the at least one component (B) is in the range from ≥0.1 wt. % to ≤90 wt. %, based on the total weight of the composition.
29. The composition according to embodiments 27 to 28, wherein the frother (C) is selected from the group consisting of pine oil, aliphatic C₅-C₈ alcohols, cresylic acids, polyglycols and polyglycol ethers.
30. The composition according to embodiments 27 to 29, wherein the frother (C) is present in an amount in the range of ≥0 wt. % to ≤70 wt. %, based on the total weight of the collector composition.
31. The composition according to embodiment 28, wherein the modifier (D) is selected from the group consisting of linseed Oil, quebracho, tannin, and acidified sodium dichromate.

32. The composition according to embodiments 28 or 31, wherein the modifier (D) is present in an amount in the range of ≥0 wt. % to ≤70 wt. %, based on the total weight of the collector composition.

### EXAMPLES

The presently claimed invention is illustrated in detail by non-restrictive working examples which follow. More particularly, the test methods specified hereinafter are part of the general disclosure of the application and are not restricted to the specific working examples.

### Materials

tall oil fatty acid is available from Kraton
soybean oil fatty acid is available from Oleon.
ethoxylated polyethyleneimine is available from BASF.
triethylene tetraamine is available from BASF.
isotridecanol is available from BASF.
ethoxylated branched isotridecanol is available from BASF.
fluorosilicic acid is available from Sigma Aldrich

### Example 1

The ore portion for each test was grinded in a laboratory ball mill. The component A used for the collector mixtures was a condensation product of distilled soybean oil and triethylene tetraamine in a molar ratio of 1:1.

The bariopyrochlore fraction (remainder of the ore feed after removal of calcite and apatite by flotation and magnetite by magnetic separation; the fraction consisting of Baryte BaSO4, Pyrochlore Ca₂Nb₂O₇ and various iron/magnesium/aluminium silicates) received from a Brazilian niobium mine was wet ground to 95%-150 mesh in a laboratory ball mill. The flotation feed was placed into an 4.25 L flotation cell in a Denver flotation machine, diluted to 35% with tap water and the pH was adjusted to 3.0 using a 10% aqueous solution of fluorosilicic acid.

The ethoxylated polyethyleneimine (B1) with an average molar mass of ˜13000, with ethoxylate side chains making up 95% of the polymer molecular weight was added in the form of 1% aqueous solution to the pH adjusted flotation slurry. The slurry was conditioned for 2 to 10 minutes. The pH of the floatation slurry was maintained using fluorosilicic acid. To above flotation slurry charged condensation product of distilled soybean oil and triethylene tetraamine in a molar ratio of 1:1 (75 g/ton dry feed). The slurry was diluted to 25% solids by maintaining the pH 3.0 and the pyrochlore was collected in the froth fraction. Subsequently, the concentrate and tailings were collected, dewatered, dried, weighed, and subjected to element analysis via XRF. Results in table 1; the element contents are given as oxides.

TABLE 1

| ethoxylated | Nb | Final concentrate grade | | |
|---|---|---|---|---|
| polyethyleneimine | recovery | (element wt % in conc.) | | |
| (B1) Dosage (g/t) | (%) | Nb₂O₅ (%) | Fe₂O₃ (%) | SiO₂ (%) |
| 0 | 79.3 | 45.6 | 10.5 | 5.31 |
| 10 | 78.4 | 46.0 | 11.1 | 3.92 |
| 30 | 78.1 | 49.0 | 9.89 | 2.51 |
| 100 | 77.3 | 52.2 | 7.2 | 0.89 |

### Example 2

An igneous phosphate ore feed after magnetite removal, containing 13.7% P₂O₅ has been used for the experiments. Sample preparation included grinding and single stage desliming. The floatation experiments were performed in floatation in an open cycle with two concentrate cleaning stages (Mekhanobr design values). The sample ore was conditioned with 95 g/t collector blend and the results are tabulated in table.

Flotation water was prepared by the addition of separate components to deionized water to obtain a water composition which is given in table 2.

TABLE 2
Water composition.

| | Ions content, mg/l | | | | | |
|---|---|---|---|---|---|---|
| pH | Ca²⁺ | Mg²⁺ | SO₄²⁻ | CO₃²⁻ | Cl⁻ | Na⁺ |
| 10.0 | 23.47 | 28.62 | 240.38 | 339.69 | 41.53 | 260.31 |

The above slurry was mixed with a blend of tall oil fatty acid and ethoxylated branched isotridecanol (A) and immediately afterwards charged the ethoxylated polyethyleneimine (B1) with an average molar mass of ˜13000, with ethoxylate side chains making up 95% of the polymer molecular weight. The slurry was floated with an air flow of 1 L/min for 4 minutes. The rougher and cleaner tailings as well as the final concentrate were collected, dewatered, dried, weighed and subjected to element analysis via XRF. Results of experiments are given in table 3.

TABLE 3

| ethoxylated | Concentrate | P₂O₅ |
|---|---|---|
| polyethyleneimine | grade, | recovery |
| (B1) dosage (g\t) | wt % P₂O₅ | (%) |
| 0 | 31.2 | 83.0 |
| 50 | 31.4 | 87.3 |
| 100 | 32.3 | 91.0 |
| 150 | 31.4 | 88.2 |

It is evident from the table that the compositions of the presently claimed invention provides a solution for obtaining the concentrate with a high grade at very high recovery in the froth floatation technique with less quantity of the collector composition. The concentrate has reduced amount of silicate and Fe₂O₃ impurities.

I/We claim:

1. A composition for the beneficiation of a mineral, wherein the composition comprises:
A. at least one component (A), and
B. at least one component (B),
wherein the at least one component (A) is selected from the group consisting of anionic surfactants (A1), cationic surfactants (A2), ampholytic surfactants (A3) and non-ionic surfactants (A4), and
the at least one component (B) comprises a polymer selected from the group consisting of alkoxylated polyalkyleneimine (B1) and alkoxylated hexamethylene diamine (B2).

2. The composition according to claim 1, wherein the anionic surfactants (A1) are selected from compounds of formula (A1) or derivatives thereof,
[(G)ₘ(Z)ₙ]ₒ (A1),
wherein each G is independently selected from the group consisting of linear or branched, substituted or unsubstituted C₄-C₃₀-alkyl, linear or branched, substituted or unsubstituted C₄-C₃₀-alkenyl, linear or branched, substituted or unsubstituted C₄-C₃₀-heteroalkyl, substituted or unsubstituted C₆-C₃₀-aryl, substituted or unsubstituted C₆-C₃₀-cycloalkyl, linear or branched, substituted or unsubstituted C₄-C₃₀-heteroalkenyl, linear or branched, substituted or unsubstituted C₆-C₃₀-heterocycloalkyl and substituted or unsubstituted C₆-C₃₀-aralkyl;
each Z is independently selected from group consisting of 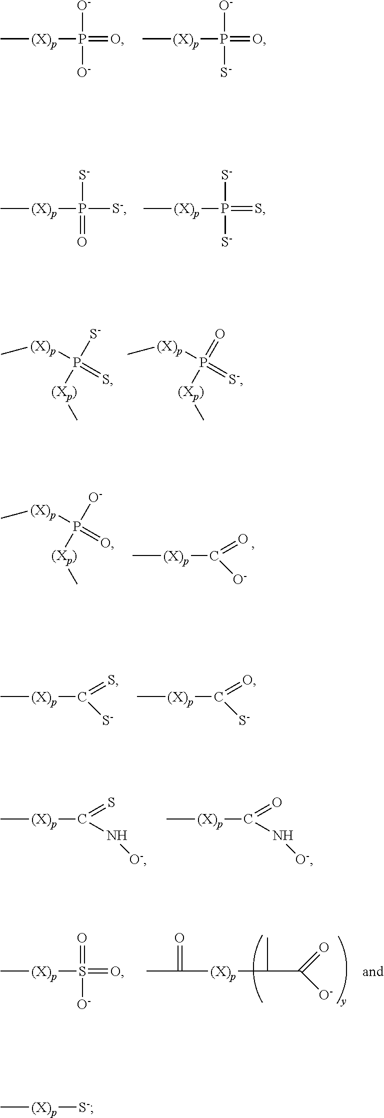
X is independently selected from the group consisting of O, S, NH and CH₂;
m is an integer in the range from 1 to 10;
n is an integer in the range from 1 to 10; and
o is in the range from 1 to 100;
y is in the range of 1 to 10; and
p is 0, 1 or 2.

3. The composition according to claim 1, wherein the anionic surfactants (A1) are selected from the group consisting of fatty acids, alkyl sulfates, alkyl sulfosuccinates, alkyl sulfosuccinamates, acyl sarcosides, N-acylaminoacids, alkyl benzene sulfonates, alkyl sulfonates, petroleum sulfonates, acyl lactylates and salts thereof.

4. The composition according to claim 3, wherein the fatty acid is selected from the group consisting of saturated or unsaturated C₄-C₃₀ fatty acids and mixtures thereof, salts of saturated or unsaturated C₄-C₃₀ fatty acids and mixtures thereof, and condensation products of saturated or unsaturated C₄-C₃₀ fatty acids and mixtures thereof.

5. The composition according to claim 4, wherein the saturated or unsaturated C₄-C₃₀ fatty acids and mixtures thereof are selected from the group consisting of octanoic acid, nonanoic acid, decanoic acid, undecanoic acid, dodecanoic acid, tridecanoic acid, tetradecanoic acid, pentadecanoic acid, hexadecanoic acid, heptadecanoic acid, isostearic acid, octadecanoic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid and mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends and derivatives thereof.

6. The composition according to claim 4, wherein the saturated or unsaturated C₄-C₃₀ fatty acids and mixtures thereof are selected from the group consisting of f tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends and derivatives thereof.

7. The composition according to claim 1, wherein the cationic surfactants (A2) are selected from the group consisting of primary aliphatic amines, linear or branched polyethyleneimine, alkyl-substituted alkylenediamines, hydroxyalkyl-substituted alkylene diamines, quaternary ammonium compounds and salts thereof, 3-C₄-C₃₀ alkoxypropane-1amines and salts thereof, N-(3-C₄-C₃₀ alkoxypropyl)-1,3-diaminopropane and salts thereof, fatty amido amine and condensation products of a saturated or unsaturated C₄-C₃₀ fatty acid and a polyalkylene polyamine.

8. The composition according to claim 7, wherein the polyalkylene polyamine is selected from the group consisting of triethylene tetraamine, N¹,N^{1′}-(ethane-1,2-diyl)bis(propane-1,3-diamine), trimethylene diamine, hexamethylene di amine, octamethylene diamine, di(heptamethylene)triamine, tripropylene tetraamine, tetraethylene pentaamine, trimethylene diamine, pentamethylene hexamine and di(trimethylene)triamine.

9. The composition according to claim 1, wherein the ampholytic surfactants (A3) are selected from compounds which contain at least one anionic group and at least one cationic group in the molecule.

10. The composition according to claim 9, wherein the compounds which contain at least one anionic and at least one cationic group in the molecule are selected from N-substituted sarcosides, taurides, betaines, N-substituted aminopropionic acids and N-(1,2-dicarboxyethyl)-N-alkylsulfosuccinamates or a compound of formula (A3a) 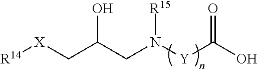
formula (A3a)
R¹⁴ is selected from the group consisting of linear or branched, substituted or unsubstituted C₁-C₃₀-alkyl, linear or branched, substituted or unsubstituted C₂-C₃₀-alkenyl, R¹⁵ is selected from the group consisting of hydrogen, linear or branched, substituted or unsubstituted C₁-C₃₀-alkyl, linear or branched, substituted or unsubstituted C₂-C₃₀-alkenyl, X, Y=independent of each other selected from the group consisting of CH₂, NH or O; and n is an integer in the range of 0 to 6.

11. The composition according to claim 1, wherein the non-ionic surfactants (A4) are selected from linear or branched C₆-C₁₈ alcohols, alkoxylated linear or branched C₆-C₁₈ alcohols, kerosene, transformer oils and synthetic hydrocarbon oils.

12. The composition according to claim 11, wherein the alkoxylated linear or branched C₆-C₁₈ alcohol has a degree of alkoxylation in the range of 0.1 to 30, or wherein the alkoxylated linear or branched C₆-C₁₈ alcohol is ethoxylated and/or propoxylated isotridecanol with a degree of branching between 1 and 3.

13. (canceled)

14. The composition according to claim 11, wherein the linear or branched C₆-C₁₈ alcohol is isotridecanol with a degree of branching between 1 and 3

15. The composition according to claim 1, wherein the alkoxylated polyalkyleneimine (B1) has a weight average molecular weight Mw in the range from 3000 to 250,000 g/mol, as determined according to GPC, which has 80 to 99% by weight ethylene oxide side chains, based on total alkoxylated polyalkyleneimine (B1).

16. The composition according to claim 1, wherein the alkoxylated hexamethylene diamine (B2) has a weight average molecular weight Mw in the range from 2000 to 100,000 g/mol, as determined according to GPC.

17. The composition according to claim 1, wherein the at least one alkoxylated polyalkyleneimine (B1) is selected the group consisting of ethoxylated polyethylenimine (B1a) and propoxylated polyethyleneimine (B1b).

18. The composition according to claim 1, wherein the amount of the at least one component (A) is in the range from ≥10 wt. % to ≤99.9 wt. %, based on the total weight of the composition.

19. The composition according to claim 1, wherein the amount of the at least one component (B) is in the range from ≥0.1 wt. % to ≤90 wt. %, based on the total weight of the composition.

20-26. (canceled)

27. A collector composition for the beneficiation of a mineral comprising:
A. at least one component (A),
B. at least one component (B),
C. at least one frother (C),
wherein the at least one component (A) is selected from the group consisting of anionic (A1) surfactants, cationic (A2) surfactants, ampholytic (A3) surfactants and non-ionic surfactants (A4), and
the at least one component (B) comprises a polymer selected from the group consisting of alkoxylated polyalkyleneimine (B1) and alkoxylated hexamethylene diamine (B2);
wherein the amount of the at least one component (A) is in the range from ≥10 wt. % to ≤99.9 wt. %, based on the total weight of the composition; and the amount of the at least one component (B) is in the range from ≥0.1 wt. % to ≤90 wt. %, based on the total weight of the composition.

28. A collector composition for the beneficiation of a mineral comprising:
A. at least one component (A),
B. at least one component (B),
C. at least one frother (C), and
D. at least one modifier (D),
wherein the at least one component (A) is selected from the group consisting of anionic (A1) surfactants, cationic (A2) surfactants, ampholytic (A3) surfactants and non-ionic surfactants (A4), and
the at least one component (B) comprises a polymer selected from the group consisting of alkoxylated polyalkyleneimine (B1) and alkoxylated hexamethylene diamine (B2);
wherein the amount of the at least one component (A) is in the range from ≥10 wt. % to ≤99.9 wt. %, based on the total weight of the composition and the amount of the at least one component (B) is in the range from ≥0.1 wt. % to ≤90 wt. %, based on the total weight of the composition.

29.-32. (canceled)
